(19) United States
(12) Patent Application Publication
(10) Pub. No.: US 2026/0230936 A1
(43) Pub. Date: Aug. 6, 2026

(54) ACCESS NETWORK NODE, CORE NETWORK NODE, USER EQUIPMENT, AND METHOD

(71) Applicant: NEC CORPORATION, Tokyo (JP)

(72) Inventors: Zhe CHEN, Guildford (GB); Xueiong WANG, Guildford (GB); Neeraj GUPTA, London (GB)

(73) Assignee: NEC CORPORATION, Tokyo (JP)

(21) Appl. No.: 19/150,544

(22) PCT Filed: Jan. 24, 2024
(86) PCT No.: PCT/JP2024/002050

§ 371 Date: Jul. 24, 2025

(30) Foreign Application Priority Data
Jan. 27, 2023 (GB) 2301235.4

(51) Int. Cl. H04W 36/00; H04W 36/32; H04W 76/20

(52) U.S. Cl. CPC H04W 36/0016; H04W 36/0058; H04W 36/322; H04W 76/20

(57) ABSTRACT

The present disclosure relates to a method of an access network node, the method comprising: obtaining predicted mobility information that indicates a predicted mobility of a user equipment, UE; performing a handover procedure for handover of the UE to another access network node; and transmitting, the predicted mobility information to the another access network node; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

### TECHNICAL FIELD

The present disclosure relates to an access network node, a core network node, a user equipment, and methods therefor.

### BACKGROUND ART

The present disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The present disclosure has particular, although not necessarily exclusive, relevance to predictions of mobility in the so-called ‘5G’ or ‘New Radio’ systems (also referred to as ‘Next Generation’ systems), and similar systems.

Recent developments of the 3GPP standards are referred to as the Long-Term Evolution (LTE) of Evolved Packet Core (EPC) network and Evolved Universal Mobile Telecommunications Service (UMTS) Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

### CITATION LIST

### Non Patent Literature

NPL 1: Next Generation Mobile Networks (NGMN) Alliance, ‘NGMN 5G White Paper’, V1.0, 17 Feb. 2015
NPL2: 3GPP TS 38.331, “NR; Radio Resource Control (RRC) protocol specification”, V17.2.0 (2022-09)

### SUMMARY OF INVENTION

### Technical Problem

Some of the additional developments in 3GPP relate to the use of artificial intelligence (AI) and machine learning (ML), often abbreviated to AI/ML. Several use cases have been proposed for AI/ML, one being in the context of UE mobility. AI/ML can be used to predict the path of a UE, for example based on previous movements of the UE between cells. The predicted mobility of the UE can then be used to optimise the communications network, resulting in increased efficiency and performance. However, improved methods of sharing information related to the mobility of the UE between the nodes in the communication network are needed, so that improved predictions of mobility of the UE can be made at one or more of the network nodes. For example, when a base station uses AI/ML to predict a mobility of the UE, there is a need for improved methods in which information regarding the actual mobility of the UE is fed back to the base station so that the AI/ML model can be improved based on the feedback. This can be particularly challenging when handover of the UE occurs, after which the base station may no longer be in direct communication with the UE.

More generally, there is a need for improved methods of predicting the mobility (e.g. movements between cells) of UEs, to enable a more efficient and reliable communication network.

The present disclosure aims to provide apparatus and methods that at least partially address the above needs and/or issues.

### Solution to Problem

A first aspect of the present disclosure provides a method of a network node, the method including:

transmitting a message including predicted mobility information indicating a predicted mobility of a user equipment, UE, to another network node for mobility of the UE;

wherein the predicted mobility information includes at least one of: information indicating an accuracy of the predicted mobility, information indicating a mobility model used to generate the predicted mobility, or information indicating at least one input for the mobility model to generate the predicted mobility.

A second aspect of the present disclosure provides a method of a network node, the method including:
receiving, from another network node, predicted mobility information indicating a predicted mobility of the UE, for mobility of the UE;
wherein the predicted mobility information includes at least one of: information indicating an accuracy of the predicted mobility, information indicating a mobility model used to generate the predicted mobility, or
information indicating at least one input for the mobility model to generate the predicted mobility.

A third aspect of the present disclosure provides a method of a core network node, the method including:
receiving, from a network node, predicted mobility information indicating a predicted mobility of a user equipment, UE, for mobility of the UE; and
transmitting the predicted mobility information to another network node;
wherein the predicted mobility information includes at least one of: information indicating an accuracy of the predicted mobility, information indicating a mobility model used to generate the predicted mobility, or
information indicating at least one input for the mobility model to generate the predicted mobility.

A fourth aspect of the present disclosure provides a method of a user equipment, UE, the method including:
transmitting, to a network node, a first measurement report indicating a result of a measurement performed by the UE;
receiving, from the network node, an indication to cause the UE to transmit, to another network node, a second measurement report indicating a result of a second measurement performed by the UE, in a Radio Resource Control, RRC, Reconfiguration Complete message, after the first measurement report is transmitted to the network node; and
transmitting the second measurement report to the another network node, and
wherein the second measurement report is used for generating a feedback of a predicted mobility of the UE.

A fifth aspect of the present disclosure provides an access network node including:
means for transmitting, predicted mobility information indicating a predicted mobility of a user equipment, UE, to the another network node for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

A sixth aspect of the present disclosure provides an access network node including:
means for receiving, from another network node, predicted mobility information indicating a predicted mobility of the UE, for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

A seventh aspect of the present disclosure provides a core network node including:
means for receiving, from a network node, predicted mobility information indicating a predicted mobility of a user equipment, UE, for mobility of the UE; and
means for transmitting the predicted mobility information to another access network node;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

An eighth aspect of the present disclosure provides a user equipment, UE, including:
means for transmitting, to a network node, a first measurement report indicating a result of a first measurement performed by the UE;
means for receiving, from the network node, an indication to cause the UE to transmit, to another network node, a second measurement report indicating a result of a second measurement performed by the UE, in a Radio Resource Control, RRC, Reconfiguration Complete message, after the first measurement report is transmitted to the network node;
means for transmitting the second measurement report to the another network node, and
wherein the second measurement report is used for generating a feedback of a predicted mobility of the UE.

### BRIEF DESCRIPTION OF DRAWINGS

Example embodiments of the present disclosure will now be described, by way of example, with reference to the accompanying drawings in which:

FIG. 1 schematically illustrates a mobile (‘cellular’ or ‘wireless’) communication system;

FIG. 2 illustrates a typical frame structure that may be used in the communication system of FIG. 1;

FIG. 3 is a schematic block diagram illustrating the main components of a DU 50 that may be used as part of the RAN equipment 5 for the communication system 1 shown in FIG. 1;

FIG. 4 is a schematic block diagram illustrating the main components of a CU 60 that may be used as part of the RAN equipment 5 for the communication system 1 shown in FIG. 1;

FIG. 5 shows a mobility procedure in which handover occurs from a source (R)AN node to a target (R)AN node;

FIG. 6 shows an example of Intra-CU inter-Du mobility;

FIG. 7 shows a method for L1/L2-based inter-cell mobility;

FIG. 8 shows an example of intra-DU mobility;

FIG. 9 shows Intra-DU handover to additional PCI;

FIG. 10 shows an inter-cell inter-DU method;

FIG. 11 shows a base station triggered L1 mobility method including measurement report filtering;

FIG. 12 shows an inter-cell inter-DU method including conditional handover;

FIG. 13 shows an inter-cell inter-DU method including an L1 measurement report reconfiguration;

FIG. 14 shows a schematic diagram illustrating the interactions between nodes of a system, when using Artificial Intelligence/Machine Learning;

FIG. 15 shows an example of an AI/ML request and an AI/ML response;

FIG. 16 shows an example of an AI/ML information update;

FIG. 17 shows an example of UE mobility information feedback;

FIG. 18 shows a further example of UE mobility information feedback;

FIG. 19 is a schematic block diagram illustrating the main components of a UE for the communication system of FIG. 1;

FIG. 20 is a schematic block diagram illustrating the main components of a base station for the communication system of FIG. 1; and

FIG. 21 is a schematic block diagram illustrating the main components of a core network node or function for the communication system of FIG. 1.

### DESCRIPTION OF EMBODIMENTS

### Overview

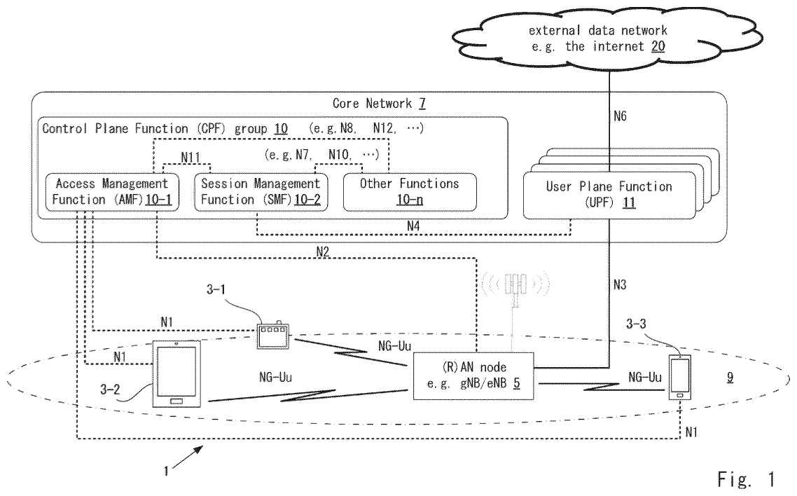

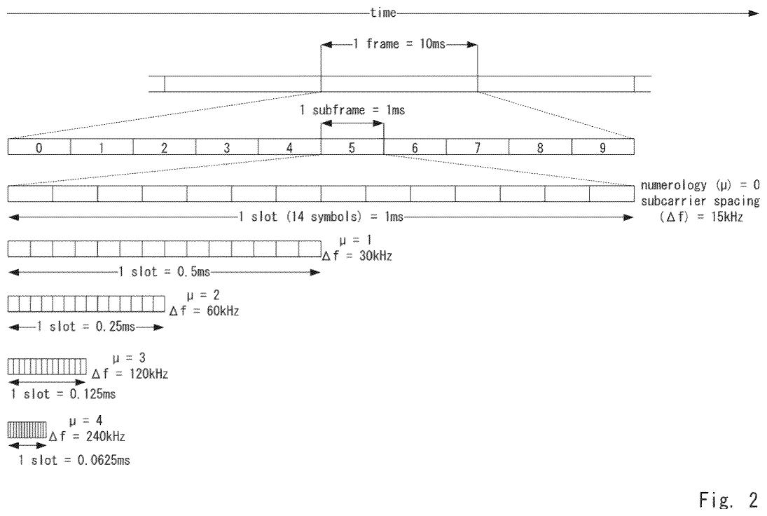

An exemplary communication system will now be described in general terms, by way of example only, with reference to FIGS. 1 and 2.

FIG. 1 schematically illustrates a mobile (‘cellular’ or ‘wireless’) communication system 1 to which example embodiments of the present disclosure are applicable.

In the communication system 1, user equipments (UEs) 3-1, 3-2, 3-3 (e.g. mobile telephones and/or other mobile devices) can communicate with each other via a radio access network (RAN) node 5 (base station 5, RAN equipment 5) that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicity ServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, a cell specific reference signal, a UE-specific reference signal (UE-RS), a downlink demodulation signal (DMRS), and a channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, a demodulation reference signal (DMRS) for a UL control/data signal, and/or a sounding reference signal (SRS) used for UL channel measurement.

When the UE 3 initially establishes a radio resource control (RRC) connection with a base station 5 via a cell it registers with an appropriate core network node (e.g., AMF, MME). The UE 3 is in the so-called RRC connected state and an associated UE context is maintained by the network. When the UE 3 is in the so-called RRC idle or in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station 5 may be split into separate control-plane and user-plane entities, each of which may include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### <Frame Structure>

Referring to FIG. 2, which illustrates a typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of u can, in effect, be derived from μ=0 by scaling up in powers of 2 (i.e. SCS=15×2^{μ} kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### <RAN Equipment>

### DU

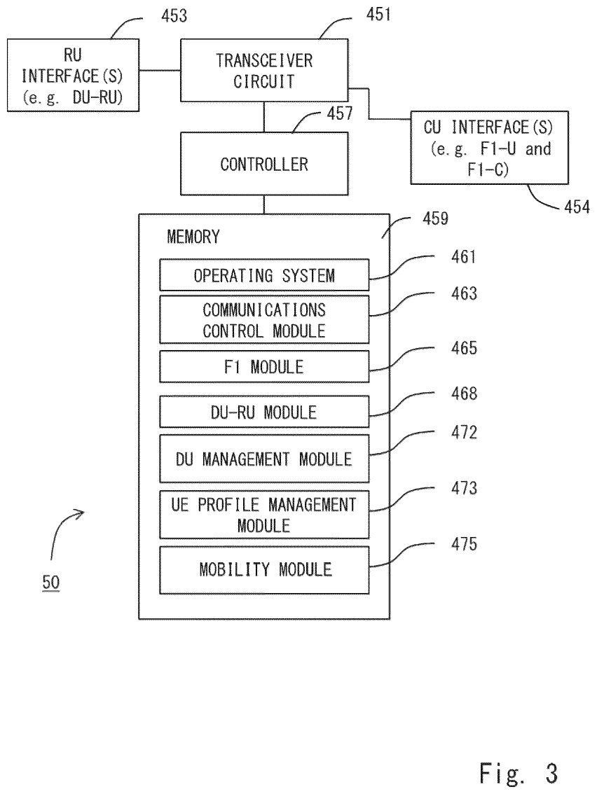

FIG. 3 is a schematic block diagram illustrating the main components of a DU 50 that may be used as part of the RAN equipment 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signalling respectively).

The DU 50 has a controller 457 to control the operation of the DU 50. The controller 457 is associated with a memory 459. Software may be pre-installed in the memory 459 and/or may be downloaded via the communication system 1 or from a removable data storage device (RMD) for example. The controller 457 is configured to control the overall operation of the DU 50 by, in this example, program instructions or software instructions stored within memory 459.

As shown, these software instructions include, among other things, an operating system 461, a communications control module 463, an F1 module 465, a DU-RU module 468, a UE profile management module 473 and a mobility module.

The communications control module 463 is operable to control the communication between the DU 50 and one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications destined for the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. The UE profile management module 473 may also store previous mobility information for a UE 3 (e.g. previous movements of the UE 3 between different communication cells of the network). The previous mobility information may be for use in any of the AI/ML methods related to UE 3 mobility described below. It will be appreciated that, depending on implementation, the gNB-DU may not implement at least some of these features.

The mobility module 475 is responsible for controlling mobility procedures of one or more UEs 3. For example, the mobility module 475 may be configured to perform one or more measurements for UE 3 mobility, or to select a candidate cell for handover. It will be appreciated that the mobility module 475 may be configured to perform control in any of the mobility methods (e.g. handover) described below.

### CU

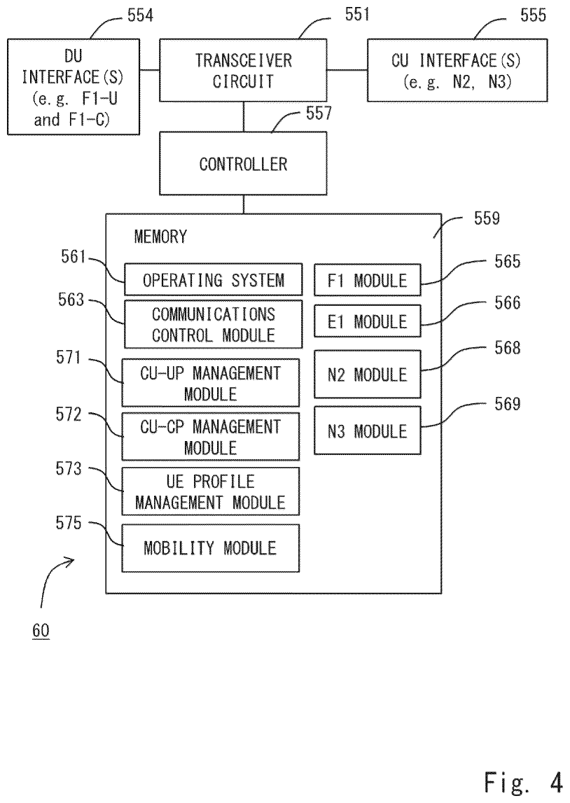

FIG. 4 is a schematic block diagram illustrating the main components of the CU 60 of the RAN equipment for the communication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communication system 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for handling the transmission of downlink communications destined for the UE 3.

The F1 module 565 is responsible for the appropriate processing of signals received from, or transmitted to, the DU 50 via one or more DU (e.g. F1) interfaces 554. These signals may be separated into: user plane signals received at, or transmitted by, the CU-UP part of the CU via the F1-U interface; and control plane signals received at, or transmitted by, the CU-CP part of the CU via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via one or more corresponding core network interfaces (e.g. N2) 555.

The N3 module 569 is responsible for the appropriate processing of signals received from, or transmitted to, one or more core network user plane functions via one or more corresponding core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. The UE profile management module 573 may also store previous mobility information for a UE 3 (e.g. previous movements of the UE 3 between different communication cells of the network). The previous mobility information may be for use in any of the AI/ML methods related to UE 3 mobility described below. It will be appreciated that, depending on implementation, the CU 60 may not implement at least some of these features.

### <System Information and SIB>

It will be appreciated that transmissions in a cell 9 of a base station 5 may include one or more broadcast transmissions and one or more unicast transmissions for reception by a UE 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by a UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions. The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. For example, SIB2 provides information for intra-frequency, inter-frequency and inter-system cell reselection, SIB3 provides cell-specific information for intra-frequency cell reselection, and SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using MSG1 (random access preamble), which may be referred to as a MSG1-based on-demand SI request, or MSG3 (RRC Connection Request), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block consists of 240 contiguous subcarriers. When the UE 3 is in an RRC connected mode, the base station 5 may provide the UE 3 with an indication of resources used for the SS/PBCH, for example using dedicated signalling (e.g. for an anchor NES cell or a non-anchor NES cell). SIB1 may be transmitted using a physical downlink shared channel (PDSCH). The OSI may be similarly transmitted, for example, using a PDSCH.

When one or more beamformed transmissions are transmitted in a cell provided by the base station 5, some of the SI (e.g. some of the SIB) may only be transmitted using particular beams, or using a particular transmission/reception point (TRP).

### <UE Mobility>

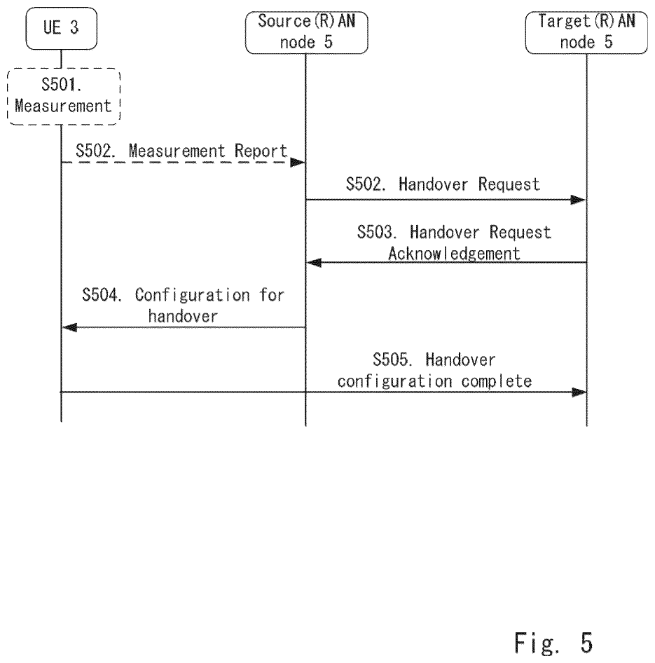

FIG. 5 shows an overview of a mobility procedure that may be performed in a communication system of the type illustrated in FIG. 1. In this example, a handover of a UE 3 from a source base station 5 to a target base station 5 occurs. However, as will be discussed in more detail later, handover may also occur, for example, between two DUs 50, or between two cells associated with the same DU 50.

In optional step S501 the UE 3 performs a measurement. The measurement may be a measurement of a signal transmitted by the source (R)AN node 5 or of a signal transmitted by the target (R)AN node 5. The measurement may be a measurement of a signal strength that can be used in a determination that the UE 3 is to be handed over from the source (R)AN node 5 to the target (R)AN node. In optional step S501 the UE 3 transmits a corresponding measurement report to the source (R)AN node 5. The source (R)AN node may use information provided in the measurement report to determine that the UE 3 is to be handed over to the target (R)AN node 5. However, it will be appreciated that a determination that handover is to be performed may also be performed based on a measurement performed at the source (R)AN node 5 or at the target (R)AN node 5. Alternatively, a determination that handover is to be performed may be based on a factor other than a signal measurement, such as a level of congestion in a cell operated by the source (R)AN node 5.

In Step S502 the source (R)AN node 5 transmits a handover request to the target (R)AN node 5. In step S503 the target (R)AN node transmits a corresponding acknowledgement of the handover request.

In step S504, the source (R)AN node transmits a configuration for the handover to the UE 3. The configuration for the handover may be, for example, an RRC configuration transmitted in an RRC reconfiguration message.

In step S505, the UE 3 applies the received configuration for handover and transmits an indication to the target (R)AN node that configuration is complete. The message transmitted in step S505 may be, for example, an RRC Reconfiguration Complete message.

Some exemplary types of UE 3 mobility procedures that may be performed in a communication system will now be described in more detail.

### Conditional Handover (CHO)

A Conditional Handover (CHO) is a handover that is executed by the UE 3 when one or more handover execution conditions are met. The UE 3 starts evaluating one or more execution conditions upon receiving a CHO configuration, and stops evaluating one or more execution conditions once the handover is executed. The execution conditions may be based, for example, on measurements performed by the UE 3 of reference signal received power (RSRP), reference signal received quality (RSRQ), RSRP and signal to noise interference ratio (RSRP-SINR). For layer 1/layer 2 (L1/L2) mobility, handover is initiated based on L1/L2 measurement results.

An example of CHO will now be described. A ‘CHO candidate cell’ is a candidate cell for CHO, and has a corresponding CHO configuration. The CHO configuration comprises the configuration of one or more CHO candidate cells generated by the candidate base stations 5 and one or more execution conditions generated by the source base station 5.

An execution condition may comprise, for example, one or two trigger conditions, which may also be referred to as CHO events.

As in intra-NR RAN handover, in intra-NR RAN CHO, the preparation and execution phase of the conditional handover procedure may be performed without involvement of the core network; i.e. preparation messages are directly exchanged between base stations 5. The release of the resources at the source base station during the conditional handover completion phase is triggered by the target base station 5.

In a CHO method, the source base station 5 may determine that CHO should be used. The source base station 5 may request CHO for one or more candidate cells belonging to one or more candidate base stations 5. A CHO request message can then be sent for each candidate cell.

The candidate base stations 5 send a CHO response, including a configuration of one or more CHO candidate cells, to the source base station 5. The CHO response message may be sent for each candidate cell.

The source base station 5 may send an RRC Reconfiguration message to the UE 3, containing the configuration of one or more CHO candidate cells and one or more CHO execution conditions.

The UE 3 may send an RRC Reconfiguration Complete message to the source base station 5.

If early data forwarding is applied, the source base station 5 may sends an early status transfer message.

The UE 3 maintains connection with the source base station after receiving CHO configuration, and starts evaluating the CHO execution conditions for one or more candidate cells. If at least one CHO candidate cell satisfies the corresponding CHO execution condition, the UE 3 detaches from the source base station, applies the stored corresponding configuration for that selected candidate cell, synchronises to that candidate cell and completes the RRC handover procedure by sending an RRC Reconfiguration Complete message to the target base station 5. The UE 3 releases stored CHO configurations after successful completion of RRC handover procedure.

A target base station 5 sends the handover success message to the source base station 5 to inform that the UE 3 has successfully accessed the target cell. In return, the source base station 5 sends a sequence number status transfer (e.g. SN STATUS TRANSFER) message.

The source base station 5 can then send a handover cancel message toward the other signalling connections or other candidate target base stations, if any, to cancel CHO for the UE 3.

Conditional configurations for a conditional handover may be provided as a ‘delta configuration’ with respect to the configuration of the serving cell. In other words, parameters and setting for the conditional configuration may be indicated by indicating the differences between the conditional configuration and the configuration of the serving cell.

A UE 3 may be configured to indicate to another entity in the communication system 1 that the UE 3 supports conditional handover by, for example, transmitting a signal that includes an indication in a conditional handover field or information element.

A CHO candidate cell list can be used to indicate a list of candidate target cells for a conditional handover. A candidate target cell for CHO may be referred to as a CHO candidate. For example, up to 8 candidate cells with associated conditional handover execution conditions may be configured for a UE 3. The number of execution conditions may be two (alternatively one execution condition, or three or more execution conditions, could conceivably be used). The UE 3 executes the CHO towards a selected target cell when the conditions are met by applying the corresponding conditional reconfigurations. This improves mobility robustness since the CHO configuration can be sent before the serving cell quality drops, and the UE 3 may avoid mobility failure due to a missed HO command.

### Intra-CU Inter-DU Mobility

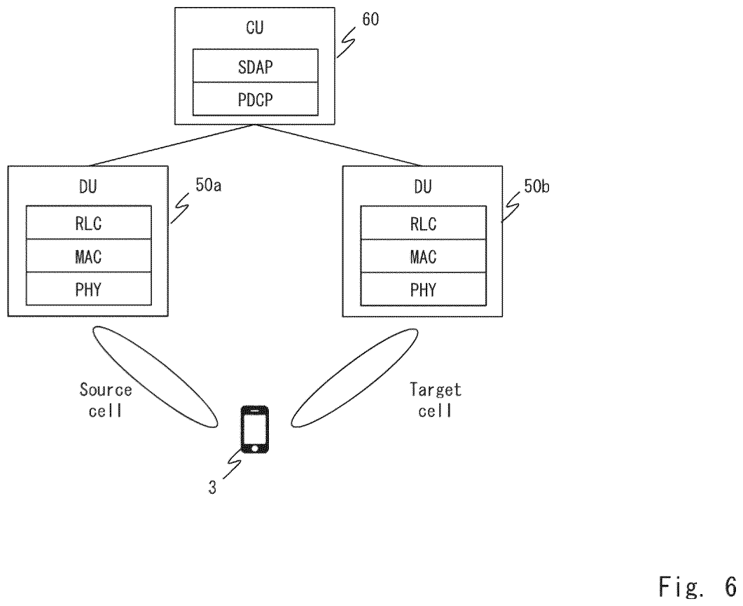

FIG. 6 shows an example of Intra-CU inter-DU mobility.

In this case, the current serving cell and the candidate cells share the same CU. Since the source cell and the target cell are located in different DU, radio link control (RLC) layer is re-established, and the medium access control (MAC) layer is reset.

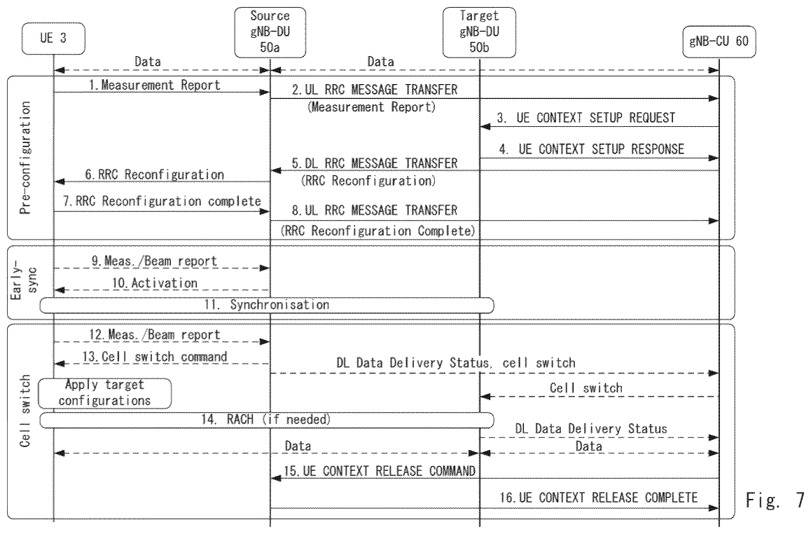

FIG. 7 illustrates an exemplary method of inter-DU mobility. A procedure for L1/L2-based inter-cell mobility from a source DU 50a to a target DU 50b is shown (however, it will be appreciated that inter-DU mobility need not necessarily be L1/L2-based). As show in the figure, the method comprises a pre-configuration stage, an early-synchronisation stage, and a cell switch stage, described below.

### <Pre-Configuration>

In steps 1 and 2, the UE 3 sends a layer 3 (L3) measurement report to the source DU 50a based on measurement configurations. The measurement report is forwarded to the CU 60.

In steps 3 to 8 the CU 60 determines a candidate set for the UE 3, sends a preparation request to the target DU 50b and receives a corresponding acknowledgement from the target DU 50b. Then the CU 60 sends the RRC reconfiguration to the UE 3 and receives a corresponding RRC reconfiguration complete message, via the source DU 50a.

### <Early Synchronisation>

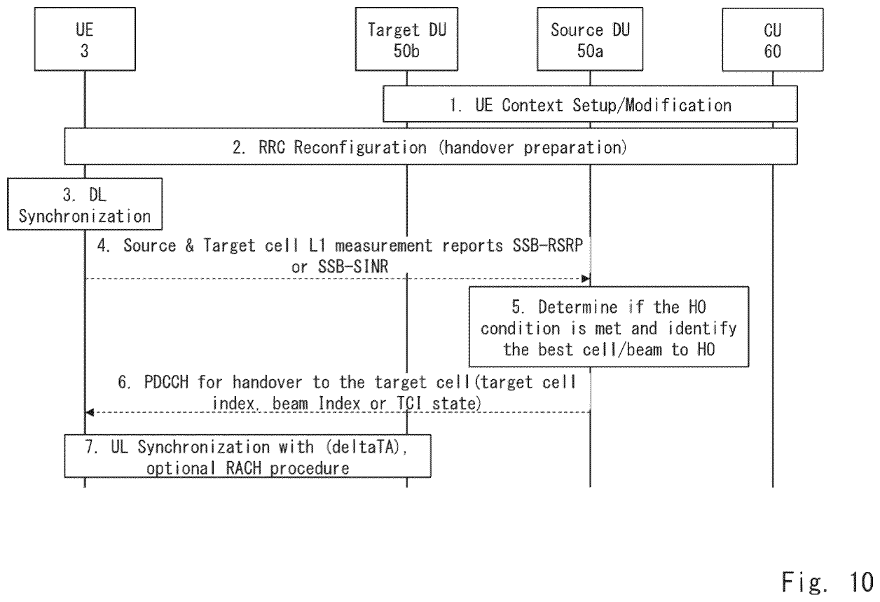

In steps 9 to 11 the UE 3 performs L1 measurements and reports for reference signals (e.g. SSB or CSI-RS illustrated in FIG. 10) corresponding to inter-cell beams, based on configurations from the network. Based on L1 measurement reports, the communication system 1 may activate some transmission configuration information (TCI) states quasi co-located (QCL-ed) with cells whose physical cell ID (PCI) is different from serving cell. The UE 3 performs synchronisation (DL and optionally UL) for these cells.

### <Cell Switch>

In steps 12 to 13, based on further L1 reports, the DU 50 may indicate a target cell and beam (TCI state). The UE 3 applies target cell configurations. In step 14, if timing advance (TA) is not available, the UE 3 performs RACH towards the indicated target cell. In steps 15 and 16 the UE 3 receives PDCCH from target cell using new TCI state.

### Intra-DU Mobility

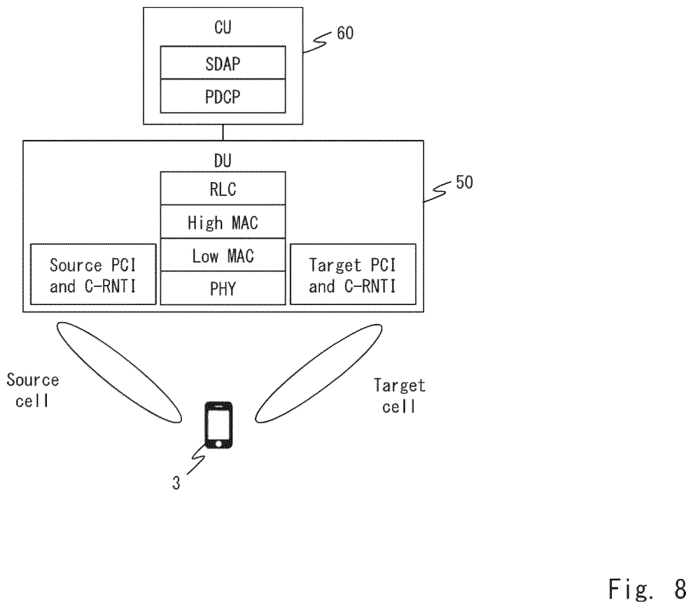

FIG. 8 shows an example of Intra-DU mobility. In this case, the current serving cell and the candidate cells share the same CU and DU, and there is no need for PDCP, RLC to be re-established.

### Intra-DU Handover to Additional PCI

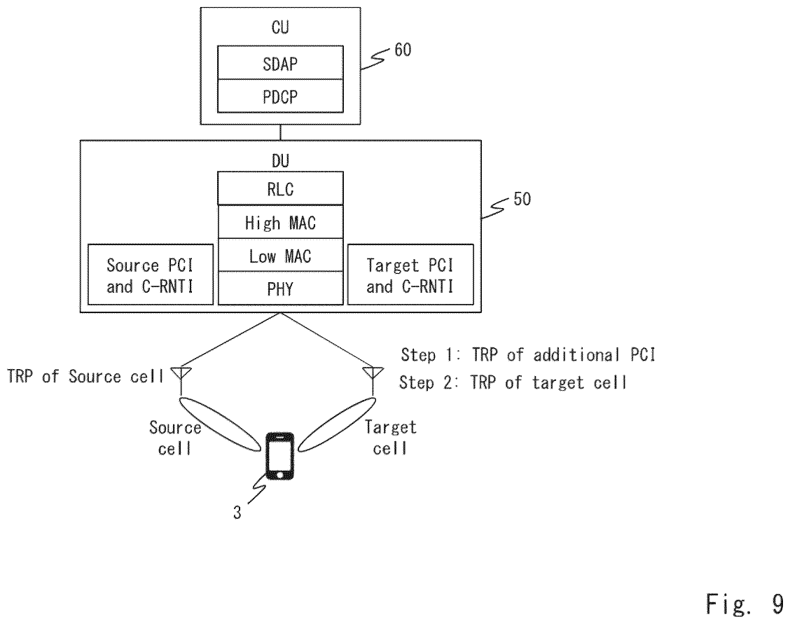

FIG. 9 shows an example of Intra-DU handover to additional physical cell ID (PCI). Within intra-DU, there is a case in which the UE 3 receives physical downlink shared channel (PDSCH) from a transmission reception point (TRP) associated with an additional PCI (different from current serving cell's PCI). In this scenario, MAC reset may not be needed.

### Inter-Cell Inter-DU

FIG. 10 shows an inter-cell inter-DU method.

In step 1, UE Context Setup/Modification is performed (e.g. in which the CU transmits a UE context/setup modification request message to the target DU).

In step 2, RRC Reconfiguration (handover preparation) is performed.

In step 3, DL Synchronization is performed.

In step 4, Source & Target cell L1 measurement reports SSB-RSRP or SSB-SINR are transmitted from the UE 3 to the source DU 50a.

In step 5, a determination of whether the HO condition is met is performed, and the best cell/beam for HO is identified.

In step 6, a physical downlink control channel (PDCCH) for handover to the target cell (which may include a target cell index, beam Index or TCI state) is transmitted from the source DU 50a to the UE 3.

Step 7 comprises UL Synchronization (which may include transmission of a delta timing advance (deltaTA) described below), and an optional RACH procedure.

### Base Station Triggered L1 Mobility

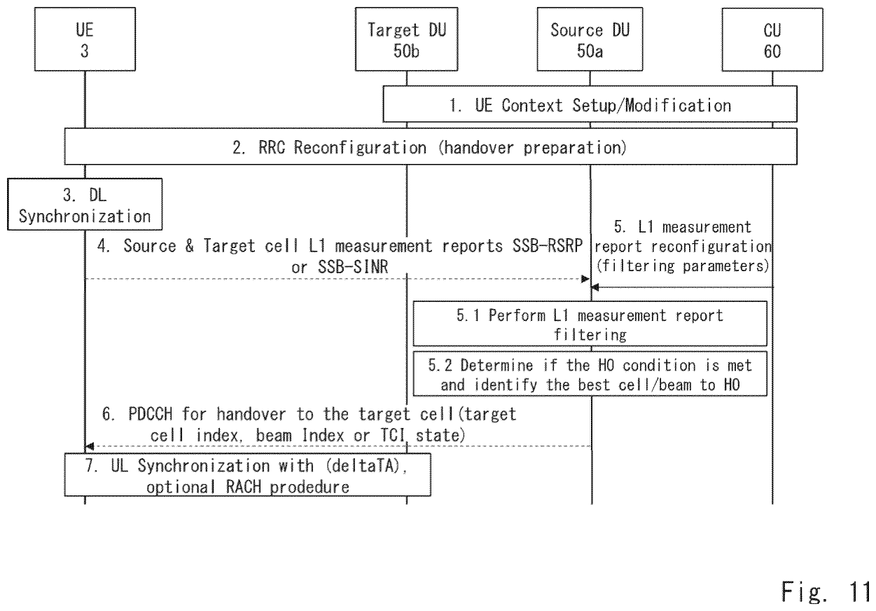

FIG. 11 shows a base station triggered L1 mobility method including measurement report filtering.

Steps 1 to 4 of FIG. 11 correspond to steps 1 to 4 of FIG. 10.

In step 5, an L1 measurement report reconfiguration (which may include one or more filtering parameters) is transmitted from the CU 60 to the source DU 50a.

In step 5.1, L1 measurement report filtering is performed at the source DU 50a.

Step 5.2 of FIG. 11 corresponds to step 5 of FIG. 10.

Steps 6 and 7 of FIG. 11 correspond to steps 6 and 7 of FIG. 10.

### Inter-Cell Inter-DU Method Including Conditional Handover

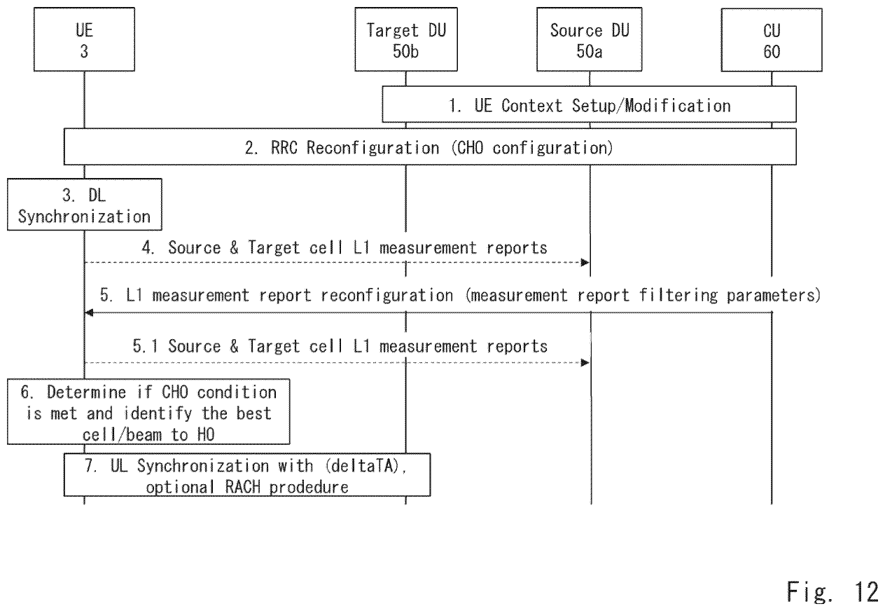

FIG. 12 shows an inter-cell inter-DU method including conditional handover.

In step 1, UE Context Setup/Modification is performed.

In step 2, RRC Reconfiguration (CHO configuration) is performed.

In step 3, DL Synchronization is performed at the UE 3.

In step 4, Source & Target cell L1 measurement reports are transmitted from the UE 3 to the source DU 50a.

In step 5, L1 measurement report reconfiguration (which may include measurement report filtering parameters) is transmitted from the CU 60 to the UE 3.

In step 5.1, Source & Target cell L1 measurement reports are transmitted from the UE 3 to the source DU 50a.

In step 6, the UE determines if one or more CHO conditions are met and identifies the best cell/beam for HO.

Step 7 of FIG. 12 corresponds to step 7 of FIG. 11.

### Inter-Cell Inter-DU Method Including Conditional Handover

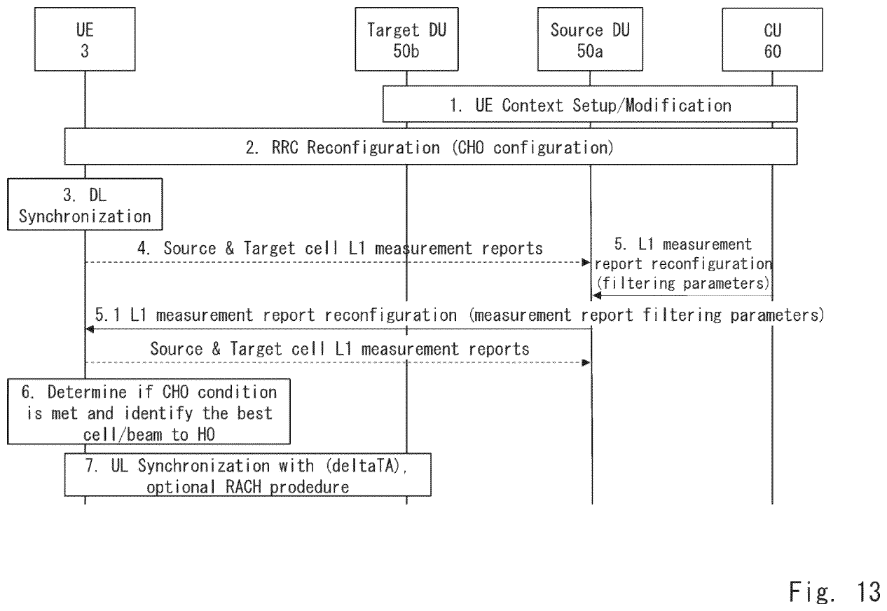

FIG. 13 shows an inter-cell inter-DU method including an L1 measurement report reconfiguration. As can be seen in the figure, FIG. 13 shows a modification of the method shown in FIG. 12 in which an L1 measurement report reconfiguration (which may include filtering parameters) is transmitted from the CU 60 to the source DU 50a, and the L1 measurement report reconfiguration (which may include measurement report filtering parameters, as described in more detail below) is transmitted from the source DU 50a to the UE 3.

In step 1 of FIGS. 10 to 13, handover preparation may include measurement configuration and Inter-DU synchronisation signal block (SSB) SS/PBCH Block Measurement Timing Configuration (SMTC) co-ordination. SMTC is an SSB-based measurement timing configuration.

In step 2 of FIGS. 10 to 13, RRC Reconfiguration may include measurement configuration, measurement report configuration, Target Cell List and random access channel (RACH) configuration, SMTC (Inter-DU) SSB-related information of the Target Cell and associated DU-ID, and inter-frequency measurement gap configuration. If the measurement gap is used, inter-frequency measurement may be performed from OFDM symbols corresponding to the overlapped time span between SMTC window duration and the measurement gap, as defined by higher layer for the minimum measurement time.

Regarding step 4 of FIGS. 10 to 13, it is noted that SSB based radio link monitoring (RLM), beam management (BM) and beam failure recovery (BFR) may be outside an active bandwidth part (BWP). A beam measurement report may contain a candidate cell ID, or use implicit mapping of beam index to a neighbour cell and hence the associated DU-ID.

If handover does not occur upon timer expiry, the source cell may initiate measurement reporting again via PDCCH that includes a one bit ‘start/stop’ indication.

In FIGS. 10 to 13, the DCI may indicate the new target beam Index or TCI state.

### <Artificial Intelligence (AI)/Machine Learning (ML)>

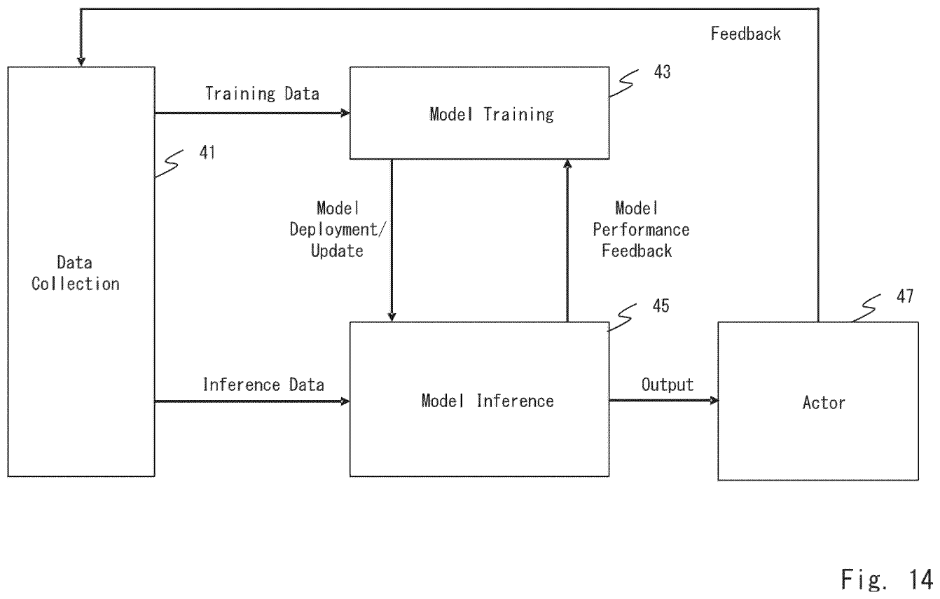

FIG. 14 shows a functional framework in respect of AI/ML, and how various entities of the framework may interact with one another.

The entities include a data collection function 41, a model training function 43, a model inference function 45, and an actor 47. The data collection function 41 provides input data (training data) to the model training function 43 and the model inference function 45. The collected data may be, for example, data regarding mobility (e.g. handover of a UE 3). For example, the data may be collected by a base station 5 (e.g. by receiving a measurement report from a UE 3, or by receiving data from another base station 5 or a core network node/function) and transmitted to another base station 5 that generates the AI/ML model inference output (or alternatively, the same base station that obtains the data may generate the AI/ML model output). The model training function 43 performs the ML model training, validation, and testing which may generate model performance metrics as part of a model testing procedure. The model inference function 45 provides AI/ML model inference output (e.g., predictions or decisions), and the actor 47 is a function or node that receives the output from the model inference function 45 and triggers or performs corresponding actions (e.g. a base station 5 that increases/reduces its transmit power, or initiates a handover procedure for a UE 3). The AI/ML model inference output may be, for example, a prediction of mobility (e.g. expected path, route or trajectory, inter-cell or inter-beam mobility, or expected handover) of a UE 3. The functions illustrated in FIG. 14 may be co-located at a single node of the communications network (e.g. at a base station 5 or core network node/function), or may be distributed amongst a plurality of network nodes (e.g. a plurality of base stations 5).

Terms referred to by 3GPP in the context of this framework include:

AI/ML Model: A data driven algorithm by applying machine learning techniques that generates a set of outputs including predicted information and/or decision parameters, based on a set of inputs.

AI/ML Training: An online or offline process to train an AI/ML model by learning features and patterns that best present data and get the trained AI/ML model for inference.

AI/ML Inference: A process of using a trained AI/ML model to make a prediction or guide a decision (e.g. handover decision) based on collected data (e.g. UE 3 mobility information) and AI/ML model.

Training Data: Data for input to the AI/ML Model Training function.

Inference Data: Data for input to the AI/ML Model Inference function.

Model Deployment/Update: Used to initially deploy a trained, validated, and tested AI/ML model to the Model Inference function or to deliver an updated model to the Model Inference function.

As will be described in more detail below, the data collection function 41 may be performed at various nodes of the communication network (e.g. at one or more base stations 5). Improved methods of collecting data regarding the mobility of one or more UEs 3 will be described, for use in generating predictions of future UE 3 mobility. Moreover, improved methods of transmitting the feedback to one or more nodes of the communication network will be described.

### <AI/ML for UE Mobility>

Improved methods of using AI/ML for predicting mobility (e.g. a predicted route/path, inter-cell or inter-beam mobility, or handover) of a UE 3 will now be described. It will be appreciated that the mobility of the UE 3 may include any of the types of handover described above, or any other suitable mobility procedure (e.g. inter-beam mobility). Prediction of the location or mobility of a UE 3 advantageously enables more efficient operation of the communication network. For example, radio resource management (such as selection of target handover cells) can be performed more efficiently using a predicted mobility of the UE 3. The predicted mobility of the UE 3 can also be used for early data forwarding (for example, for use in a CHO procedure, such as one of the CHO procedures described above).

As discussed above with reference to FIG. 14, information collected by nodes/functions in the communication network can be used as training data for an AI/ML model, and used as inference data for use in generating one or more model inferences using the AI/ML model. The information used as training data and/or to generating the one or more model inferences may be referred to as ‘AI/ML information’. Methods of requesting and transmitting AI/ML information will now be described.

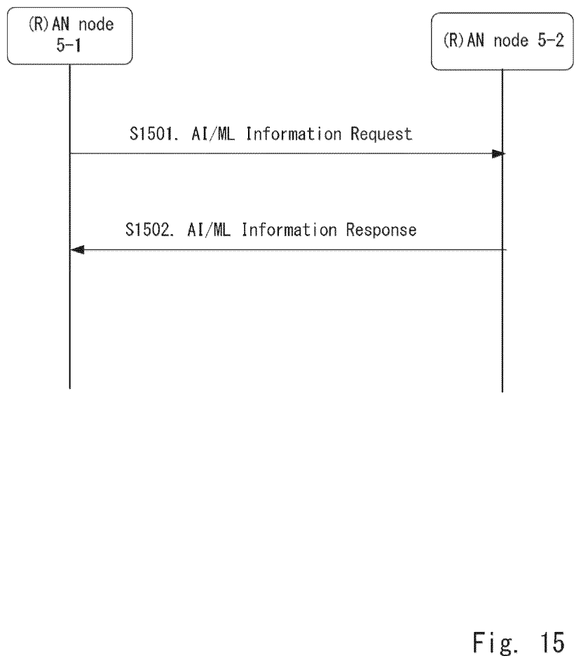

FIG. 15 shows an example of an AI/ML information request and an AI/ML response. In Step S1501, the first base station 5-1 transmits an AI/ML information request to the second base station 5-2. The AI/ML request is a request for AI/ML information (e.g. information regarding an actual mobility of a UE 3) from the second base station 5-2.

After receiving the AI/ML information request in step S1501, the second base station 5-2 transmits an AI/ML Information Response to the first base station 5-1 that includes the AI/ML information. The second base station 5-2 may also begin periodic reporting of the AI/ML information to the first base station 5-1 in response to receiving the AI/ML information request. The periodic reporting may be configured using a corresponding AI/ML information reporting configuration indicated by the AI/ML information request (e.g. including a periodicity of the reporting, number of reports, or reporting duration/time period). The AI/ML information request may include an information element (IE) that indicates that the second base station 5-2 is to start or stop periodic reporting of the AI/ML information to the first base station 5-1. The AI/ML information request may alternatively be a request for a single report of AI/ML information from the second base station 5-2, rather than for periodic reporting.

If the second base station 5-2 is unable to transmit the requested AI/ML information to the first base station 5-1 (e.g. because the requested information is not available at the second base station 5-2), then the second base station 5-2 may transmit a corresponding indication to the first base station 5-1 that the second base station 5-2 is unable to provide the requested information, for example an AI/ML information failure message. The AI/ML information failure message may include an indication of why the second base station 5-2 is unable to provide the requested AI/ML information (e.g. a cause value).

Upon receipt of the AI/ML information, the first base station 5-1 may use the AI/ML information to train (or update) a corresponding AI/ML model (e.g. for UE 3 mobility), or to generate a prediction (e.g a prediction of UE 3 mobility). Alternatively, the first base station 5-1 may forward the AI/ML information to another network node, for use with an AI/ML model at that network node.

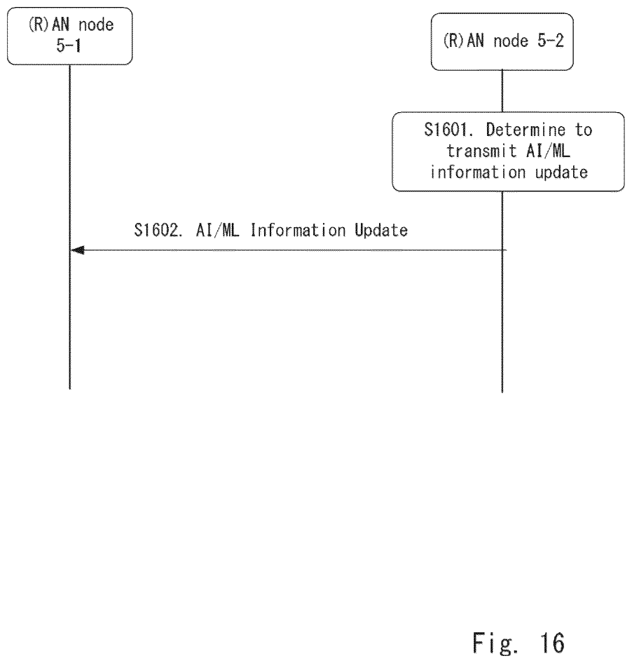

Whilst in the example shown in FIG. 15 the AI/ML information response may include the requested AI/ML information, alternatively the AI/ML information response may be an indication that the second base station 5-2 will transmit the AI/ML information in a subsequent AI/ML information update (e.g. an acknowledgement of the AI/ML information request). FIG. 16 shows an example of an AI/ML information update. In step S1601 the second base station 5-2 determines to transmit an AI/ML information update to the first base station 5. For example, the second base station 5-2 may determine to transmit the AI/ML information update to the first base station 5-2 based on a reporting periodicity received by the second base station 5-2 in step S1501 of FIG. 15, or may determine to transmit the AI/ML information update based on a change in AI/ML information stored at the second base station 5 (or based on new AI/ML information obtained at the second base station 5-2). In step S1602 the second base station 5-2 transmits the AI/ML information to the first base station 5-1 in the AI/ML information update.

### Predicted UE Mobility

Improved methods of transmitting predicted mobility of a UE 3 to nodes/functions in the communication network will now be described. The predicted mobility of the UE 3 may be generated using an AI/ML model, for example using the AI/ML information received in step S1602 of FIG. 16. The predicted mobility of the UE 3 (which may also be referred to as predicted mobility information, or AI/ML model output information) may include a predicted route, path, trajectory, or direction of travel, of the UE 3, or may be an indication of a predicted inter-cell or inter-beam mobility of the UE 3, for example.

### <Inter-Base Station Scenario>

In an inter-base station handover scenario (for example, one of the inter-base station handover methods described above), the present inventors have realised that the predicted mobility of the UE 3 can advantageously be included in a handover request message (e.g. in Step S502 of FIG. 5), enabling the target base station 5 to make use of the predicted UE 3 mobility information (e.g. for more efficient configuration of resources at the target base station 5).

The handover request message transmitted in step S502 may include predicted UE mobility information (e.g. predicted UE trajectory). As described above, the predicted UE mobility information may indicate a predicted route, path or future location of the UE 3, or predicted inter-cell or inter-beam mobility of the UE 3.

The handover request message may include a predicted UE mobility accuracy, that indicates an accuracy of the prediction. The predicted UE mobility accuracy may be, for example, expressed as a percentage (e.g. as a percentage probability that the prediction is correct or accurate), or in any other suitable format (e.g. as a number of standard deviations). The prediction accuracy may indicate the accuracy of the prediction of the route, path or location of the UE 3, and/or may indicate the accuracy of a prediction of a duration that the UE 3 will remain in a particular location (e.g. in a particular cell).

The handover request message may include improved UE history information. For example, rather than merely reporting UE 3 history information (e.g. previous locations) of the UE 3 at the cell level, the UE history information may include the location history of the UE 3 at the beam level, tracking area (TA) level, or RAN based notification area (RNA) level.

The handover request message may include an indication of the identity of the AI/ML model used to generate the predicted UE 3 mobility. The handover request message may also include an indication of the inputs into the AI/ML model that were used to generate the predicted UE 3 mobility. For example, the handover request message may include an indication of the UE mobility type (e.g. high speed, low speed, medium speed), UE type (e.g. internet of things (IoT) UE, wearable UE, Redcap UE, stationary UE), and/or UE location information or UE fingerprint (e.g. radio frequency fingerprint) input into the AI/ML model.

Whilst the present example of UE mobility information and prediction accuracy information has been described with reference to a handover request message, this need not necessarily be the case. Alternatively, the UE mobility information and/or prediction accuracy information could be included in any other suitable type of transmission to the target base station (e.g. via the UE 3 and the handover configuration complete message of step S505).

The received information could be used, for example, to train or retrain an AI/ML model at the target base station 5, beneficially enabling a more accurate prediction of future mobility of the UE 3 to be determined using the AI/ML model at the target base station 5.

### <Inter-DU Scenario>

An improved method of inter-DU handover will now be described. The inter-DU handover may be, for example, any of the inter-DU handover scenarios described above (e.g. with reference to FIG. 6).

During the inter-DU handover, the CU may transmit a UE context setup/modification request message to the target DU (e.g. as described with reference to step 1. of FIG. 10). The UE context setup/modification request message may enable, for example, the target base station 5 to set up signalling radio bearers (SRBs) and data radio bearers (DRBs).

Advantageously, in this example, the UE context setup/modification request message includes UE history information at the cell level, beam level, TA level, or RNA level, enabling the target base station 5-2 to more efficiency configure resources (e.g. time or frequency radio resources) during the handover procedure.

The UE context setup/modification request message may advantageously include the predicted mobility information of the UE 3, as described above for the inter-base station scenario. Similarly, the UE context setup/modification request message may include the AI/ML model identity, prediction accuracy, and/or AI model inputs, as described above for the inter-base station scenario.

### <NG Handover Scenario>

An improved next generation (NG) handover (NGHO) scenario will now be described. During NGHO, the predicted UE mobility may be transmitted to the target base-station via the AMF. In a first example, the predicted UE mobility may be transferred via the source base station to the target base station in a transparent container (e.g. using a source NG-RAN Node to Target NG-RAN Node Transparent Container IE in a next generation application protocol (NGAP) ‘handover required’ message). Alternatively, the predicted UE mobility information may be transmitted in an NGAP handover request message, using an appropriate AI/ML prediction information element. The information transmitted to the target base station via the AMF may include the predicted mobility information of the UE 3, as described above for the inter-base station scenario. Similarly, the information transmitted to the target base station via the AMF may include the AI/ML model identity, prediction accuracy, and/or AI model inputs, as described above for the inter-base station scenario.

As illustrated in FIG. 14, feedback may be used to improve the AI/ML model (e.g. by training the AI/ML using the feedback), or to verify the accuracy of the AI/ML model. For example, the feedback may be used to determine that the AI/ML model is to be retrained. In this example, feedback may be returned to the source base station via the AMF. The feedback information may be transferred using an NGAP procedure, such as a RAN AI/ML information transfer procedure. Advantageously, therefore, the source base station 5 is able to improve the accuracy of the AI/ML model, or verify that the AI/ML model is operating as intended (or within an acceptable accuracy range). The feedback that is transmitted to the source base station may include, for example, information indicating the actual location/mobility of the UE, or any other suitable mobility information. Similarly, in the Inter-base station and inter-DU examples described above, the feedback may be transmitted to from the target base station/DU to the source base station/DU (e.g. directly or via an intermediate network node) using any suitable message or transmission.

### <Beam-Level Prediction/Feedback Information>

As described above, the UE mobility prediction may include a prediction of the mobility of the UE 3 at the cell level. However, alternatively, the mobility prediction can advantageously be made at the beam level. Mobility prediction at the beam level enables more efficient configuration of resources to be performed at the target base station, due to the increase in precision of the prediction. Similarly, the feedback that is returned to the node that operates the AI/ML model may be feedback at the beam level, rather than merely at the cell level, enabling the accuracy of the AI/ML model to be determined at the beam level rather than at the cell level. For both the mobility prediction information and the mobility feedback information, the information may be provided at the beam level instead of at the cell level, or alternatively in addition to the information at the cell level. The level of granularity (e.g. cell-level, beam-level) may be configurable by the network.

### UE Mobility Feedback

Examples will now be described in which, following handover from a source base station 5, mobility feedback information (e.g. actual UE 3 location or mobility, which could be, for example, on a cell level or beam level) for an AI/ML model is transmitted to the source base station 5 (e.g. from the target base station, or another base station). As described above, the feedback can be used at the source base station 5 to verify the accuracy of the AI/ML model, to trigger retraining of the AI/ML model, or used to generate a further prediction using the AI/ML model. However, in the present examples, since handover of the UE 3 away from the source base station 5 has occurred the feedback information may not be available directly at the source base station 5, and so is transmitted to the source base station by another node of the communication network (e.g. another base station, such as the target base station or a further base station).

After receiving the mobility feedback information, the source base station 5 may determine that the prediction accuracy of the AI/ML model is too low, and may determine to retrain the AI/ML model. Advantageously, therefore, a scenario in which the AI/ML model becomes unacceptably inaccurate can be avoided.

In the present example, the source base station 5 is the node of the network at which the AI/ML model predictions are generated (and at which the AI/ML is retrained, when needed). The source base station 5 may therefore be referred to as the primary base station 5 (or primary RAN node 5). In other words, the AI/ML architecture is centralised at a particular base station 5. However, this need not necessarily be the case, and alternatively the AI/ML architecture may be provided at another node/function in the communication network, such as a core network node/function. The primary base station 5 (or other network node that hosts the AI/ML model) may request AI/ML information from other nodes in the communication network (e.g. another base station 5) using the procedure described above with reference to FIGS. 15 and 16. Alternatively, or additionally, other nodes in the network may determine to transmit the AI/ML information to the primary base station even without having received an AI/ML information request from the primary base station 5. For example, a target base station 5 may determine to transmit AI/ML mobility information to the primary base station 5 in response to handover of the UE 3 to the target base station (e.g. after a predetermined time following the handover, or in response to a further handover of the UE 3 from the target base station).

The selection of the primary base station 5 may be configurable by the network. The primary base station 5 may be selected for a particular UE 3, for example based on one or more characteristics of the UE 3 (e.g. mobility characteristics). By way of example, a UE 3 may typically move between a home of the user and an office of the user on a particular weekday. The home or office falls within the coverage area of a particular base station 5, which may be selected to serve as the primary base station for the AI/ML model for the UE 3, since this base station is the most likely to have the greatest amount of information regarding the mobility characteristics of the UE 3. When the UE 3 is handed over from the primary base station 5 to a target base station 5 in a handover procedure (e.g. to a base station that provides an area of coverage in which there is a shopping centre that the user visits at the weekend), the target base station may receive a mobility prediction generated using the AI/ML mobility model from the primary base station 5 during the handover procedure (e.g. in step S502 of FIG. 5). The target base station 5 may also feed back information to the primary base station 5 regarding the actual mobility (e.g. trajectory) of the UE 3, so that the primary base station 5 has improved knowledge of the mobility of the UE 3 (which can then be used, for example, at the primary base station 5 to verify the accuracy of the AI/ML model predictions, as described above).

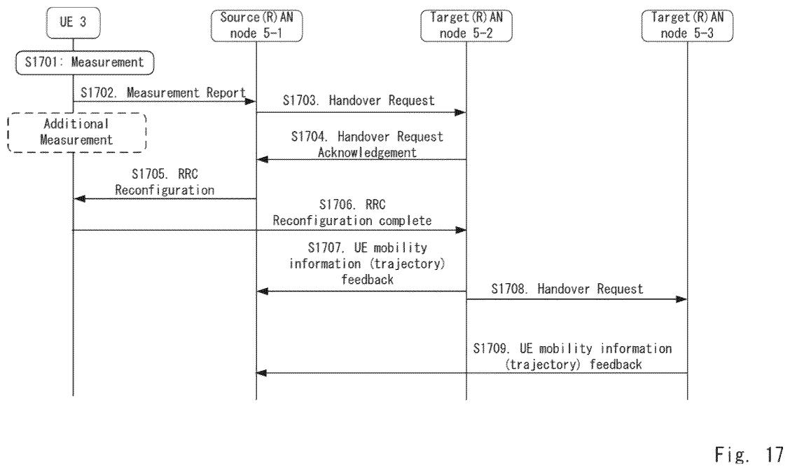

FIG. 17 shows an example in which UE mobility information is fed back to the source base station 5-1 following a handover of the UE 3 to a first target base station 5-2, and a subsequent handover to a second target base station 5-3. In this example, the source base station 5-1 is the primary base station and hosts the AI/ML model for predicting the mobility of the UE 3. Advantageously, information obtained at the second target base station 5-3 regarding the mobility of the UE 3 can be fed back to the source base station 5-1 even when the source base station 5-1 does not have a direct communication link with the second target base station 5-3.

Steps S1701 and S1702 are the same as steps S501 and S502 of FIG. 5 and so will not be described again here. It is noted that the measurement performed by the UE 3 may be generated in a time to trigger (TTT) manner, and that UE 3 may perform one or more additional measurements (shown in the dashed box in FIG. 17), which may be transmitted to the source base station 5-1 or target base station 5-2, 5-3, when appropriate.

In step S1703 the source base station 5-1 (which in this example is the primary base station for the AI/ML model) transmits a handover request to the first target base station 5-2. Advantageously, the handover request in this example includes a transaction ID (which may also be referred to as an ‘event ID’, and identifies a particular ‘transaction’ or particular handover of the UE) or UE ID (which may be an indication of the identity of the UE 3), and an indication of the identity of the primary base station 5-1 (e.g. primary base station ID, or any other suitable type of indication for identifying the node to which the feedback is to be transmitted, such as an indication that the handover request is being transmitted by the primary base station 5-1 that hosts the AI/ML model).

The transaction ID or UE ID can be used to associate feedback for the AI/ML model with the UE 3. When feedback is returned to the source base station 5-1 in association with the transaction ID or UE ID, the source base station 5-1 is able to determine that the feedback corresponds to mobility information for that particular UE 3. The transaction ID could also be used by the target base station to determine that the feedback is to be transmitted to the source base station 5-1.

The indication of the identity of the primary base station can be used by other network nodes (e.g. the first target base station 5-2 or the second target base station 5-3) to determine which network node to transmit the UE mobility feedback to. The indication of the identity of the primary network node/function enables other network nodes/functions to determine which network node/function is the primary network node/function for AI/ML model for the UE 3.

The handover request message transmitted in step S1703 may also include any of the information regarding the predicted mobility of the UE 3 for the handover request message described above (e.g. as described above with reference to the Inter-base station scenario, Inter-DU scenario, and NG handover scenario). For example, the handover request may include the predicted mobility information, the AI/ML model identity, prediction accuracy, and/or AI model inputs.

In step S1704, the first target base station 5-2 transmits a handover request acknowledgement to the source base station 5-1.

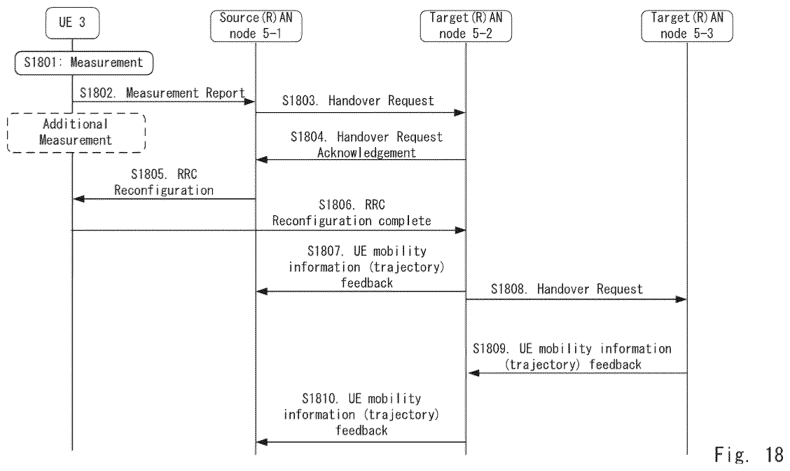

In step S1705, the source base station 5-1 transmits RRC reconfiguration information (which may be referred to as configuration information for the handover) to the UE 3 for the handover. The RRC reconfiguration information may include an indication to the UE 3 to include an indication of an additional measurement result in a subsequent transmission to the first target base station 5-2 (e.g. in the RRC reconfiguration complete message transmitted in step S1706). The indication to the UE 3 to include the indication of the additional measurement result may be referred to as an AI mobility enhancement report indication. In this example, the UE 3 includes the indication of the additional measurement result in the RRC reconfiguration complete message of step S1706 if an additional measurement was performed after the measurement report was transmitted to the source base station in step S1702 (illustrated by the dashed box in FIGS. 17 and 18). Advantageously, therefore, measurement information corresponding to a measurement obtained by the UE 3 before the handover is transmitted to at least one of the base stations, and can be fed back to the primary base station (e.g. to determine whether a decision to handover the UE to the target base station 5-2 was made appropriately or correctly, for example at an appropriate time. The target base station 5-2 may advantageously use the information to improve a handover decision process at the target base station 5-2). Whilst in this example the AI mobility enhancement report indication is transmitted to the UE 3 in the RRC reconfiguration message, the indication may alternatively be transmitted to the UE 3 in any other suitable transmission (e.g. in a dedicated transmission after receiving the handover request acknowledgement from the target base station 5-2, and before transmitting the RRC reconfiguration message to the UE 3).

In step S1706, the UE 3 transmits the RRC reconfiguration complete message to the first target base station 5-2. The UE 3 also includes the additional measurement report, as indicated by the source base station 5-1 in the RRC reconfiguration message of step S1705.

In step S1707, the first target base station 5-2 feeds back mobility information for the AI/ML mobility model to the source base station 5-1 (that is the primary base station for the AI/ML mobility model). The information transmitted in step S1701 may be, for example, information indicating the actual mobility (e.g. trajectory) of the UE 3 after the handover. As described above, the mobility information that is fed back to the primary base station 5 may be at the cell level, beam level, TA level, RNA level, or at any other level of granularity or precision.

If the indication of the additional measurement result was received at the first target base station 5-2 from the UE 3 in step S1706, then the first target base station 5-2 includes the indication of the further measurement result in the information that is transmitted to the source base station 5-1. In this example, the UE mobility information is transmitted to the source base station 5-1 in association with the transaction ID or UE ID received in step S1703, so that the source base station 5-1 can identify which UE 3 the feedback information relates to.

In step S1708, the first target base station 5-2 transmits a handover request to a second target base station 5-3. The first target base station 5-2 may determine to transmit the handover request, for example, based on a mobility prediction received from the primary base station 5-1 in step S1703 (e.g. indicating that the UE 3 is likely to move into an area of coverage provided by a cell or beam of the second target base station 5-3). As described above for step S1703, the first target base station 5-2 includes the transaction ID or UE ID, and includes the indication of the identity of the primary base station 5-1 in the handover request message. Therefore, the second target base station 5-2 is advantageously able to determine which base station is the primary base station 5-1, and is able to transmit any subsequent feedback information for the AI/ML model for the UE 3 in association with the transaction ID or UE ID (so that the primary base station 5-1 is able to determine to which UE 3 the feedback relates). The first target base station 5-2 may also include any of the other information related to the AI/ML mobility model received from the source base station 5-1 in step S1703 (for example, the predicted UE mobility information, model identity, or model inputs).

In step S1709, in this example the second target base station 5-3 has a direct communication link (e.g. an Xn interface) to the source base station 5-1, and so transmits the UE mobility information feedback directly to the source base station 5-1. The second target base station 5-3 is advantageously able to identify the source base station 5-1 to transmit the feedback to based on the indication of the identity of the primary base station received in step S1708 from the first target base station 5-2. As described above, the mobility information fed back to the source base station 5-1 may include an actual location or mobility of the UE 3 (e.g at the cell or beam level), or any other suitable information related to the mobility of the UE 3 that can be used with the AI/ML model at the source base station 5 (e.g. a time duration for which the UE 3 is in a particular location).

FIG. 18 shows a modification of the methods of FIG. 17 in which the second target base station 5-3 transmits the UE mobility information feedback to the source base station 5-1 via the first target base station 5-2. The second target base station 5-3 may transmit the UE mobility information feedback to the source base station 5-1 via the first target base station 5-2 because, for example, the second target base station 5-3 does not have a direct communication link with the source base station 5-1 (e.g. there is no Xn interface with the source base station 5-1).

Steps S1801 to S1808 are the same as steps S1701 to S1708 described with reference to FIG. 17, and so will not be described again here.

In step S1809, the second target base station 5-3 transmits the UE mobility information feedback to the first target base station 5-2. As described above, the information transmitted in step S1809 may be, for example, information indicating the actual mobility (e.g. trajectory) of the UE 3 after the handover to the second target base station 5-3, and the feedback information is transmitted in association with the transaction ID or UE ID (so that the primary base station 5-1 is able to determine to which UE 3 the feedback relates). The transmission of step S1809 may also include the indication of the identity of the primary base station 5-1 (but need not necessarily, since the first target base station 5-2 has already received the indication of the identity of the primary base station 5-1 in step S1803 for the handover of the same UE 3).

In step S1810, the first target base station 5-2 forwards the UE mobility information feedback to the source base station 5-1. Advantageously, therefore, the source base station 5-1 (that is the primary base station for the AI/ML model and generates the mobility predictions) is able to receive the UE mobility feedback for the AI/ML model from the second target base station 5-3, even when the second target base station 5-3 does not have a direct communication link with the source base station 5-1 (e.g. there is no Xn interface).

### Distributed AI/ML Architecture

Whilst in the example described above with reference to FIGS. 17 and 18 the network includes a primary node/function that hosts the AI/ML model and generates the mobility predictions, alternatively the AI/ML model may be distributed amongst various nodes in the network. For example, a plurality of base stations 5 may host the AI/ML model and generate mobility predictions. Advantageously, whilst this may increase the processing required at some network nodes, when the AI/ML model is distributed amongst the network nodes there is beneficially a reduction in the number of mobility predictions that are transmitted between the nodes. For example, referring to FIG. 17, if the first target base station 5-2 is configured to generate a prediction of the mobility of the UE 3 using the AI/ML model, then then the first target base station 5-2 need not necessarily receive a mobility prediction from the source base station 5-1.

In this example in which the AI/ML model (or a plurality of AI/ML models—the same model need not necessarily be used at each base station 5) is provided at a plurality of base stations 5, the UE mobility feedback information can still be provided to each of the base stations that generates predictions using the AI/ML model (for example, to verify the accuracy of the model, as described above).

By way of example, a UE 3 may typically move between a home of the user and an office of the user on a particular weekday. The home or office falls within the coverage area of a first base station 5 that hosts an AI/ML model for predicting mobility of the UE 3. The UE 3 may be handed over from the first base station 5-1 to a second base station 5-2 in a handover procedure (e.g. to a base station that provides an area of coverage in which there is a shopping centre that the user visits at the weekend). In this example the second base station 5-2 also hosts an AI/ML model for predicting mobility of the UE 3. The second base station 5-2 may therefore generate a prediction of a future mobility of the UE 3 using the AI/ML model. The second base station 5-2 may also transmit UE mobility information (e.g. actual UE 3 mobility) to the first base station 5-1, for example so that the accuracy of the AI/ML model at the first base station can be verified as described above. In this example, whilst both of the base stations 5-2 are able to generate predictions of UE 3 mobility using the AI/ML model, advantageously information indicating an actual mobility (e.g. trajectory) of the UE 3 is exchanged between the base stations 5, increasing the overall accuracy of the AI/ML mobility models used in the system. Even when the second base station 5-2 hosts an AI/ML mobility model, the first base station 5-1 may still transmit a mobility prediction in the handover request (e.g. as described with reference to step S1703 of FIG. 17), since knowledge of a mobility prediction made at the first base setation 5-2 may be used to increase the accuracy of a mobility prediction made at the second base station 5-2. In other words, a mobility prediction made at the first base station 5-1 may be used as an input into the AI/ML model at the second base station 5-2. Similarly, any other suitable information such as the inputs used for the AI/ML model at the first base station 5-1, or the type or identity of the AI/ML model used at the first base station 5-1, may be transmitted to the second base station 5-2 in the handover request.

When the AI/ML model is provided at a plurality of base stations 5, the method illustrated in FIG. 17 may be performed as described above, in which information regarding the AI/ML model (including the mobility prediction, inputs into the AI/ML model, and the type or ID of the AI/ML) used at a particular base station 5 is transmitted to another base station in a handover request, and UE mobility information is fed back for use in verifying or improving the model. However, since in this example each base station hosts an AI/ML mobility model and predicts the mobility of the UE 3, in a modification of the method of FIG. 17 a handover request transmitted by a particular base station includes the information regarding the AI/ML model (including the mobility prediction, inputs into the AI/ML model, the type or ID of the AI/ML, the identity of the base station that hosts the AI/ML model, and the information indicating the transaction/UE identity) hosted at that particular base station. In contrast, for example, the AI/ML model and prediction information included in step S1708 of FIG. 17 corresponds to the AI/ML model hosted at the primary base station 5-1 (since in that example the first target base station 5-2 does not host an AI/ML mobility model). Moreover, since in this case the handover request in step S1708 would include the information regarding the AI/ML model of the first target base station 5-2, (including the mobility prediction, inputs into the AI/ML model, the type or ID of the AI/ML, the identity of the first target base station 5-1 that hosts the AI/ML model, and the information indicating the transaction/UE identity), the second target base station 5-3 transmits the UE mobility feedback of Step 1709 to the first target base station 5-2 (rather than to the source base station 5-1). Nevertheless, the first target base station 5-2 may optionally forward the UE mobility information feedback received from the second target base station 5-3 to the source base station 5-1, for example for use in verifying the AI/ML model used at the source base station 5-1 as described above.

### Configuration for AI/ML

Some further improvements related to AI/ML models will now be described. Configuration information for an AI/ML model (e.g. an indication of a type of model to use) may be exchanged between base stations (or other communication nodes/functions) using any suitable method. For example, the AI/ML model configuration information may be exchanged using an Xn setup request/response procedure. Alternatively, dedicated signalling or a dedicated procedure may be used to transmit the AI/ML model configuration information.

The AI/ML model configuration information may include a list of supported use cases (the AI/ML model need not necessarily be for predicting UE mobility). The supported use cases may be, for example: energy saving; traffic steering; anomaly detection; quality of experience (QoE) optimisation; mobility robustness optimisation (MRO); RAN slice service level agreement (SLA) assurance; massive multiple-input multiple-output (MIMO) beamforming optimisation;

network slice subnet instance (NSSI) resource allocation; optimisation coverage and capacity optimisation (CCO); mobility load balancing (MLB); RACH optimisation; or UE transmission power optimisation. The AI/ML configuration information may include an indication of a particular AI/ML model to use for a particular use case. For AI/ML mobility models, the configuration information may include the UE mobility prediction granularity (e.g. whether the mobility/trajectory prediction is at the cell level, beam level, or any other level). The AI/ML configuration information may also include an indication of whether feedback is required (e.g. from another network nodes, as described above, for example, with reference to step S1707 of FIG. 17). The feedback may include, for example, UE performance feedback (e.g. indicating a communication performance of the UE) or UE mobility/trajectory feedback (e.g. indicating an actual mobility or location of the UE).

### <User Equipment>

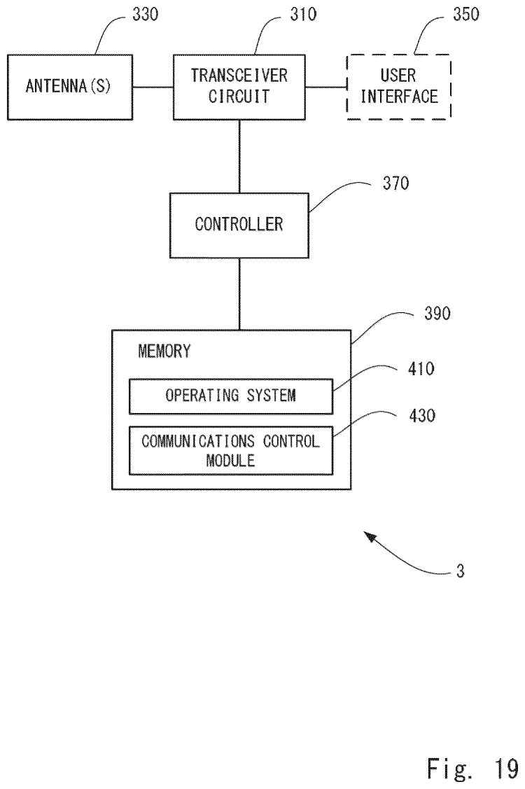

FIG. 19 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the communication network or from a removable data storage device (RMD), for example.

The controller 370 is configured to control overall operation of the UE 3 by, in this example, program instructions or software instructions stored within memory 390. As shown, these software instructions include, among other things, an operating system 410, and a communications control module 430.

The communications control module 430 is operable to control the communication between the UE 3 and its one or more serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit a measurement report according to any of the methods described above).

### <Base Station>

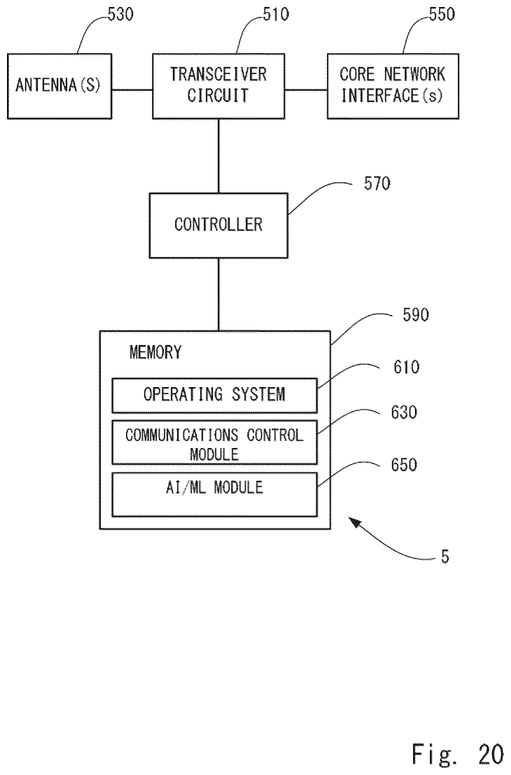

FIG. 20 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above (for example, to receive or transmit UE 3 mobility information, or a handover request).

The AI/ML module 650 is operable to use AI/ML to predict mobility of a UE 3 according to any of the methods described above. The base station 5 may be configured to train or re-train the AI/ML model as described above (for example, in response to UE mobility information that is fed back to the base station 5 from another node in the network, such as another base station 5).

### <Core Network Node/Function>

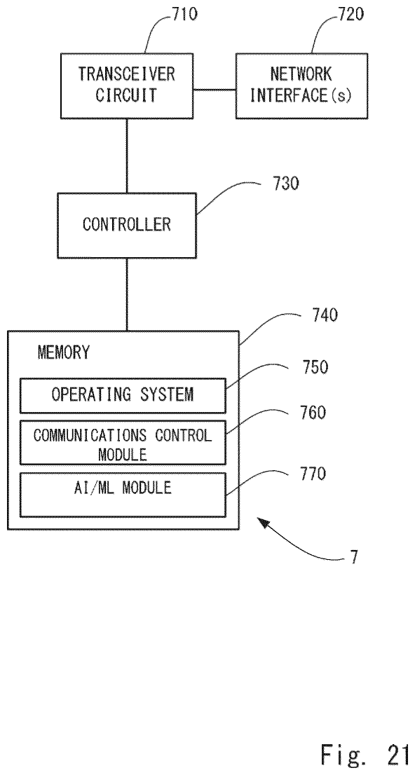

FIG. 21 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 740 and/or may be downloaded via the communication system 1 or from a removable data storage device (RMD), for example. The software includes, among other things, an operating system 750, and a communications control module 760.

The communications control module 760 is responsible for handling (generating/sending/receiving) signalling between the core network function and other nodes, such as the UE 3, the base station 5, and other core network nodes. The signalling may include for example a UE context/UE capability indication of a UE 3 related to energy saving.

As shown in FIG. 21, the core network node/function may also include an AI/ML module 770. If present, the AI/ML module 770 is operable to use AI/ML to predict mobility of a UE 3 according to any of the methods described above. The core network node/function may be configured for training or re-training the AI/ML model as described above (for example, in response to UE mobility information that is fed back to the core network node/function from another node in the network, such as a base station 5).

### MODIFICATIONS AND ALTERNATIVES

As those skilled in the art will appreciate, a number of modifications and alternatives can be made to the above example embodiments whilst still benefiting from the present disclosures embodied therein.

Whilst the AI/ML methods described above have mainly been described with reference to UE 3 mobility, the improved methods of propagating information for training/updating the AI/ML model and using the model outputs may also be applied to other types of AI/ML models and predictions. For example, the AI/ML model may output a model inference for fault prediction or security. The information used to train the AI/ML model and to generate the model inference need not necessarily be information related to UE 3 mobility.

Whilst the above examples have been described with reference to an AI/ML model, it will be appreciated that the above described methods are advantageous even when the model is not an AI/ML model. Any other suitable type of model or function may be used to predict the mobility of a UE 3. For example, the methods illustrated in FIG. 17 and FIG. 18 are useful for ensuring that mobility information is fed back to the node/function that generates mobility prediction information using the prediction model even when the model is not an AI/ML model (e.g. to verify the accuracy of model, even if the model cannot be trained or retrained). However, the methods are particularly advantageous when the model is an AI/ML model, since the information that is fed back to the primary network node/function can be used to iteratively update/train the model, or to trigger retraining.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service Area | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and example embodiments are not limited to the above-described UE and various modifications can be made thereto.

Various other modifications will be apparent to those skilled in the art and will not be described in further detail here.

In a first aspect the present disclosure provides a method of an access network node, the method comprising: obtaining predicted mobility information that indicates a predicted mobility of a user equipment, UE; performing a handover procedure for handover of the UE to another access network node; and transmitting, the predicted mobility information to the another access network node; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

Obtaining the predicted mobility information may comprise generating the predicted mobility information using the mobility model at the access network node.

The predicted mobility information may comprise an indication of a predicted location, predicted path, or predicted trajectory of the UE; and the accuracy of the predicted mobility, precision of the predicted mobility, or the uncertainty associated with the predicted mobility may comprise a spatial accuracy, precision or uncertainty, respectively, that is associated with the predicted location, predicted path, or predicted trajectory of the UE.

The predicted mobility information may comprise an indication of predicted time duration that the UE will be located in a particular location; and the accuracy of the predicted mobility, the precision of the predicted mobility, or the uncertainty associated with the predicted mobility may comprise a temporal accuracy, precision or uncertainty, respectively, that is associated with the time duration.

The predicted mobility information may include at least one of a predicted mobility of the UE at the cell level, beam level, tracking area level, or radio access network based notification area, RNA, level.

The method may further comprise: transmitting, to the another network node, previous mobility information that indicates a previous mobility of the UE; wherein the previous mobility information indicates at least one of: the previous mobility of the UE at the beam level, the previous mobility of the UE at the tracking area level, or the previous mobility of the UE at the RNA level.

The indication of at least one mobility model input that was used to generate the predicted mobility using the mobility model may comprise at least one of: an indication of a type of UE mobility; an indication of a speed or velocity of the UE; an indication of a type of UE; or an indication of a previous location of the UE.

Transmitting the predicted mobility information to the another access network node may comprise transmitting the predicted mobility information to the another access network node in a handover request message, a UE context setup request message, or a UE context modification request message.

Transmitting the predicted mobility information to the another access network node may comprise transmitting the predicted mobility information to the another access network node via a core network node.

In a second aspect the present disclosure provides a method of an access network node, the method comprising: performing a handover procedure for handover of a user equipment, UE, from another access network node to the access network node; and receiving, from the another access network node, predicted mobility information that indicates a predicted mobility of the UE; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

The method may further comprise: configuring at least one communication resource for the UE based on the predicted mobility information; or performing configuration for a subsequent handover of the UE based on the predicted mobility information.

The predicted mobility information may be received from the another access network node directly from the another access network node, or via a core network node.

In a third aspect the present disclosure provides a method of a core network node, the method comprising: performing a handover procedure for handover of a user equipment, UE, from a first access network node to a second access network node; receiving, from the first access network node, predicted mobility information that indicates a predicted mobility of a user equipment, UE; and transmitting the predicted mobility information to the second access network node; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

In a fourth aspect the present disclosure provides a method of a first access network node, the method comprising: obtaining predicted mobility information that indicates a predicted mobility of a user equipment, UE; performing a handover procedure for handover of the UE to a second access network node; and transmitting the predicted mobility information to the second access network node; wherein the predicted mobility information includes information for identifying a network node to which UE mobility feedback, that corresponds to an actual mobility of the UE after the handover has been performed, is to be transmitted.

The information for identifying the network node to which the UE mobility feedback is to be transmitted may comprise information indicating an identity of a network node that generated the predicted mobility.

Obtaining the predicted mobility information may comprise generating the predicted mobility information using a mobility model at the first access network node; and the information for identifying the network node to which the UE mobility feedback is to be transmitted may comprise an indication that the UE mobility feedback is to be transmitted to the first access network node.

The indication may be an identity of the first access network node.

The method may further comprise: receiving the mobility feedback; and using the mobility feedback to determine an accuracy of the predicted mobility, or using the mobility feedback as an input into the mobility model to generate a further predicted mobility of the UE.

The received mobility feedback may include an indication that the mobility feedback corresponds to the UE.

The indication that the mobility feedback corresponds to the UE may comprise an indication of an identity of the UE, an indication that identifies the handover of the UE to the second access network node, or an indication that identifies an event of the handover of the UE to the second access network node.

The method may comprise transmitting the indication that the mobility feedback corresponds to the UE to the second access network node with the predicted mobility information.

Obtaining the predicted mobility information may comprise receiving predicted mobility information generated by a third access network node using a mobility model; and the information for identifying the network node to which the UE mobility feedback is to be transmitted may comprise an indication that the UE mobility feedback is to be transmitted to the third access network node.

The method may further comprise at least one of: receiving the predicted mobility information directly from the third access network node, and transmitting the UE mobility feedback directly to the third access network node; or receiving the predicted mobility from a fourth access network node or a core network node, and transmitting the UE mobility feedback to the third access network node via the fourth access network node or via the core network node.

The mobility feedback may be transmitted to the third access network node with an indication that the mobility feedback corresponds to the UE.

The indication that the mobility feedback corresponds to the UE may comprises an indication of an identity of the UE, an indication that identifies the handover of the UE to the first access network node, or an indication that identifies an event of the handover of the UE to the first access network node.

The method may comprise receiving the indication that the mobility feedback corresponds to the UE with the predicted mobility information.

The mobility feedback may indicate at least one of a mobility of the UE at a cell level, a mobility of the UE at a beam level, a mobility of the UE at a tracking area level, or a mobility of a UE at a radio access network based notification area, RNA, level.

In a fifth aspect the present disclosure provides a method of a first access network node, the method comprising: performing a handover procedure for handover of the UE from a second access network node to the first access network node; and receiving, from the second access network node, predicted mobility information that indicates a predicted mobility of a user equipment, UE, generated by the second access network node using a mobility model; wherein the predicted mobility information includes information for identifying that UE mobility feedback, that corresponds to an actual mobility of the UE after the handover has been performed, is to be transmitted to the second access network node; and wherein the method further comprises transmitting the UE mobility feedback to the second access network node.

The information for identifying that UE mobility feedback is to be transmitted to the second access network node may comprise an identity of the second access network node.

In a sixth aspect the present disclosure provides a method of a first access network node, the method comprising: performing a handover procedure for handover of the UE from a second access network node to the first access network node; receiving, from the second access network node, predicted mobility information that indicates a predicted mobility of a user equipment, UE, generated by a third access network node using a mobility model; wherein the predicted mobility information includes information for identifying that UE mobility feedback, that corresponds to an actual mobility of the UE after the handover has been performed, is to be transmitted to the third access network node; and wherein the method further comprises transmitting the UE mobility feedback to the third access network node.

The information for identifying that UE mobility feedback is to be transmitted to the third access network node may comprises an identity of the third access network node.

Transmitting the UE mobility feedback to the third access network node may comprise: transmitting the UE mobility feedback directly to the third access network node; or transmitting the UE mobility feedback to the third access network node via the second access network node.

In a seventh aspect the present disclosure provides a method of a first access network node, the method comprising: receiving a measurement report from a user equipment, UE, the measurement report indicating a result of a first measurement performed by the UE in a cell of the first access network node; transmitting, to the UE, handover configuration information for a handover procedure for handover of the UE from the first access network node to a second access network node, wherein the handover configuration information includes an indication that an indication of a result of a second measurement performed by the UE in a cell of the first access network node after the measurement report is transmitted to the first access network node, is to be transmitted by the UE to the second access network node; and performing the handover procedure for handover of the UE from the first access network node to the second access network node.

The method may further comprise receiving information indicating the result of the second measurement from the second access network node.

In an eighth aspect the present disclosure provides a method of a second access network node, the method comprising: performing a handover procedure for handover of the UE from a first access network node to the second access network node; receiving an indication of a result of a measurement performed by the UE in a cell of the first access network node; and transmitting, to the first access network node, information indicating the result of the measurement performed by the UE in a cell of the first access network node.

In a ninth aspect the present disclosure provides a method of a user equipment, UE, the method comprising: transmitting a measurement report to a first access network node, the measurement report indicating a result of a first measurement performed by the UE in a cell of the first access network node; receiving handover configuration information for a handover procedure for handover of the UE from the first access network node to a second access network node, wherein the handover configuration information includes an indication that an indication of a result of a second measurement performed by the UE in a cell of the first access network node, after the measurement report is transmitted to the first access network node, is to be transmitted by the UE to the second access network node; performing the second measurement in the cell of the first access network node; performing the handover procedure for handover of the UE from the first access network node to the second access network node; and transmitting the indication of the result of the second measurement to the second access network node.

Transmitting the indication of the result of the second measurement to the second access network node may comprise transmitting the indication of the result of the second measurement to the second access network node in a radio resource control, RRC, reconfiguration complete message.

In a tenth aspect the present disclosure provides a method of an access network node in a communication network, the method comprising: receiving model configuration information for configuration of a model at the access network node, wherein the model is for generating one or more predictions corresponding to use or operation of the communication network; wherein the model configuration information comprises at least one of: an indication of a supported use of the model; an identity of a model, wherein the model identified by the identity is for use for generating the one or more predictions; and an indication of whether the access network node is to request feedback for training the model, or to request feedback for determining an accuracy of a prediction generated using the model, from another node in the communication network to which the access network node transmits the one or more predictions.

The model may be a mobility model for generating a prediction of a mobility of a user equipment, UE; and the model configuration information may include an indication of whether the mobility prediction is to be generated at the cell level, beam level, tracking area level, or radio access network based notification area, RNA, level.

The method may further comprise: transmitting a model configuration information request message to another access network node, for requesting the model configuration information from the another access network node; and receiving the model configuration information from the another access network node.

In a eleventh aspect the present disclosure provides an access network node comprising: means for obtaining predicted mobility information that indicates a predicted mobility of a user equipment, UE; means for performing a handover procedure for handover of the UE to another access network node; and means for transmitting, the predicted mobility information to the another access network node; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

In a twelfth aspect the present disclosure provides an access network node comprising: means for performing a handover procedure for handover of a user equipment, UE, from another access network node to the access network node; and means for receiving, from the another access network node, predicted mobility information that indicates a predicted mobility of the UE; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

In a thirteenth aspect the present disclosure provides a core network node comprising: means for performing a handover procedure for handover of a user equipment, UE, from a first access network node to a second access network node; means for receiving, from the first access network node, predicted mobility information that indicates a predicted mobility of a user equipment, UE; and means for transmitting the predicted mobility information to the second access network node; wherein the predicted mobility information includes information indicating at least one of: an accuracy of the predicted mobility, a precision of the predicted mobility, or an uncertainty associated with the predicted mobility; an indication of an identity of a mobility model used to generate the predicted mobility; or an indication of at least one mobility model input that was used to generate the predicted mobility using the mobility model.

In a fourteenth aspect the present disclosure provides a first access network node comprising: means for obtaining predicted mobility information that indicates a predicted mobility of a user equipment, UE; means for performing a handover procedure for handover of the UE to a second access network node; and means for transmitting the predicted mobility information to the second access network node; wherein the predicted mobility information includes information for identifying a network node to which UE mobility feedback, that corresponds to an actual mobility of the UE after the handover has been performed, is to be transmitted.

In a fifteenth aspect the present disclosure provides a first access network node comprising: means for performing a handover procedure for handover of the UE from a second access network node to the first access network node; and means for receiving, from the second access network node, predicted mobility information that indicates a predicted mobility of a user equipment, UE, generated by the second access network node using a mobility model; wherein the predicted mobility information includes information for identifying that UE mobility feedback, that corresponds to an actual mobility of the UE after the handover has been performed, is to be transmitted to the second access network node; and wherein the first access network node further comprises means for transmitting the UE mobility feedback to the second access network node.

In a sixteenth aspect the present disclosure provides a first access network node comprising: means for performing a handover procedure for handover of the UE from a second access network node to the first access network node; means for receiving, from the second access network node, predicted mobility information that indicates a predicted mobility of a user equipment, UE, generated by a third access network node using a mobility model; wherein the predicted mobility information includes information for identifying that UE mobility feedback, that corresponds to an actual mobility of the UE after the handover has been performed, is to be transmitted to the third access network node; and wherein the first access network node further comprises means for transmitting the UE mobility feedback to the third access network node.

In a seventeenth aspect the present disclosure provides a first access network node comprising: means for receiving a measurement report from a user equipment, UE, the measurement report indicating a result of a first measurement performed by the UE in a cell of the first access network node; means for transmitting, to the UE, handover configuration information for a handover procedure for handover of the UE from the first access network node to a second access network node, wherein the handover configuration information includes an indication that an indication of a result of a second measurement performed by the UE in a cell of the first access network node after the measurement report is transmitted to the first access network node, is to be transmitted by the UE to the second access network node; and means for performing the handover procedure for handover of the UE from the first access network node to the second access network node.

In an eighteenth aspect the present disclosure provides a second access network node comprising: means for performing a handover procedure for handover of the UE from a first access network node to the second access network node; means for receiving an indication of a result of a measurement performed by the UE in a cell of the first access network node; and means for transmitting, to the first access network node, information indicating the result of the measurement performed by the UE in a cell of the first access network node.

In an nineteenth aspect the present disclosure provides a user equipment, UE, comprising: means for transmitting a measurement report to a first access network node, the measurement report indicating a result of a first measurement performed by the UE in a cell of the first access network node; means for receiving handover configuration information for a handover procedure for handover of the UE from the first access network node to a second access network node, wherein the handover configuration information includes an indication that an indication of a result of a second measurement performed by the UE in a cell of the first access network node, after the measurement report is transmitted to the first access network node, is to be transmitted by the UE to the second access network node; means for performing the second measurement in the cell of the first access network node; means for performing the handover procedure for handover of the UE from the first access network node to the second access network node; and means for transmitting the indication of the result of the second measurement to the second access network node.

In a twentieth aspect the present disclosure provides an access network node in a communication network, the access network node comprising: means for receiving model configuration information for configuration of a model at the access network node, wherein the model is for generating one or more predictions corresponding to use or operation of the communication network; wherein the model configuration information comprises at least one of: an indication of a supported use of the model; an identity of a model, wherein the model identified by the identity is for use for generating the one or more predictions; and an indication of whether the access network node is to request feedback for training the model, or to request feedback for determining an accuracy of a prediction generated using the model, from another node in the communication network to which the access network node transmits the one or more predictions.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

The whole or part of the example embodiments disclosed above can be described as, but not limited to, the following supplementary notes.

### (Supplementary Note 1)

A method of a network node, the method comprising:
transmitting a message including predicted mobility information indicating a predicted mobility of a user equipment, UE, to another network node for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 2)

The method according to Supplementary Note 1, wherein
the information indicating the accuracy of the predicted mobility includes at least one of:
   information indicating an accuracy that the UE will be in a corresponding location; or
   information indicating an accuracy of a duration that the UE will stay in the corresponding location.

### (Supplementary Note 3)

The method according to Supplementary Note 1 or 2, wherein
the predicted mobility information includes a predicted trajectory of the UE and the information indicating the accuracy of the predicted mobility per location included in the predicted trajectory.

### (Supplementary Note 4)

The method according to Supplementary Note 3, wherein
granularity of the information indicating the predicted trajectory corresponds to at least one of:
   cell level,
   beam level,
   tracking area level, or
   radio access network based notification area, RNA, level.

### (Supplementary Note 5)

The method according to any one of Supplementary Notes 1 to 4, wherein
the message includes information indicating a history of a trajectory of the UE, and
wherein granularity of the information indicating the history of the trajectory of the UE corresponds to at least one of:
   cell level,
   beam level,
   tracking area level, or
   radio access network based notification area, RNA, level.

### (Supplementary Note 6)

The method according to any one of Supplementary Notes 1 to 5, wherein
the at least one input for the mobility model includes at least one of:
   a type of mobility of the UE;
   a speed or velocity of the UE;
   a type of UE; or
   a previous location of the UE.

### (Supplementary Note 7)

The method according to any one of Supplementary Notes 1 to 6, further comprising:
generating the predicted mobility information using the mobility model.

### (Supplementary Note 8)

The method according to any one of Supplementary Notes 1 to 7, wherein
the message includes at least one of:
   a handover request message,
   a UE context setup request message,
   a UE context modification request message, or
   a handover required message.

### (Supplementary Note 9)

The method according to any one of Supplementary Notes 1 to 8, wherein
the predicted mobility information is transmitted via a core network node to the another network node.

### (Supplementary Note 10)

The method according to any one of Supplementary Notes 1 to 9, wherein
the message includes an indication of the network node and a data identification or a UE identifier which corresponds to a feedback of the predicted mobility information, and the method comprises:
receiving, from the another network node or a further network node to which the UE has been handed over from the another network node, a further message including the feedback, using the indication and the data identification or the UE identifier.

### (Supplementary Note 11)

The method according to Supplementary Note 10, wherein
the feedback is based on a measurement report transmitted from the UE.

### (Supplementary Note 12)

The method according to Supplementary Note 11, further comprising:
transmitting, to the UE, a report indication to cause the UE to include the measurement report in a Radio Resource Control, RRC, Reconfiguration Complete message, wherein
the measurement report is transmitted from the UE based on the report indication.

### (Supplementary Note 13)

The method according to Supplementary Note 11 or 12, wherein
the further message includes the measurement report.

### (Supplementary Note 14)

The method according to any one of Supplementary Notes 10 to 13, wherein
the feedback includes an actual trajectory of the UE after a handover has been performed.

### (Supplementary Note 15)

The method according to any one of Supplementary Notes 10 to 14, further comprising:
using the feedback to determine the accuracy of the predicted mobility, or using the feedback as the input into the mobility model to generate a further predicted mobility of the UE.

### (Supplementary Note 16)

The method according to any one of Supplementary Notes 10 to 15, wherein
granularity of the feedback corresponds to at least one of:
   cell level,
   beam level,
   tracking area level, or
   radio access network based notification area, RNA, level.

### (Supplementary Note 17)

The method according to any one of Supplementary Notes 1 to 16, further comprising:
transmitting, to the another network node, configuration of the mobility model, and
wherein the configuration of the mobility model includes:
   information indicating at least one use case for the mobility model, and
   a respective framework of the mobility model per the at least one use case.

### (Supplementary Note 18)

The method according to Supplementary Note 17, wherein
the respective framework includes information indicating at least one of:
   granularity of a trajectory of the UE,
   need of a feedback of performance of the UE, or
   need of a feedback of an accuracy of a trajectory of the UE.

### (Supplementary Note 19)

The method according to Supplementary Note 17 or 18, wherein
the configuration is transmitted in at least one of:
   an inter-base station interface setup request message,
   an inter-base station interface setup response message,
   an inter-base station interface modification request message,
   an inter-base station interface modification response message,
   a mobility model configuration request message, or
   a mobility model configuration response message.

### (Supplementary Note 20)

A method of a network node, the method comprising:
receiving, from another network node, predicted mobility information indicating a predicted mobility of the UE, for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 21)

A method of a core network node, the method comprising:
receiving, from a network node, predicted mobility information indicating a predicted mobility of a user equipment, UE, for mobility of the UE; and
transmitting the predicted mobility information to another network node;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 22)

A method of a user equipment, UE, the method comprising:
transmitting, to a network node, a first measurement report indicating a result of a measurement performed by the UE;
receiving, from the network node, an indication to cause the UE to transmit, to another network node, a second measurement report indicating a result of a second measurement performed by the UE, in a Radio Resource Control, RRC, Reconfiguration Complete message, after the first measurement report is transmitted to the network node; and
transmitting the second measurement report to the another network node, and
wherein the second measurement report is used for generating a feedback of a predicted mobility of the UE.

### (Supplementary Note 23)

An access network node comprising:
means for transmitting, predicted mobility information indicating a predicted mobility of a user equipment, UE, to the another network node for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 24)

An access network node comprising:
means for receiving, from another network node, predicted mobility information indicating a predicted mobility of the UE, for mobility of the UE;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 25)

A core network node comprising:
means for receiving, from a network node, predicted mobility information indicating a predicted mobility of a user equipment, UE, for mobility of the UE; and
means for transmitting the predicted mobility information to another access network node;
wherein the predicted mobility information includes at least one of:
   information indicating an accuracy of the predicted mobility,
   information indicating a mobility model used to generate the predicted mobility, or
   information indicating at least one input for the mobility model to generate the predicted mobility.

### (Supplementary Note 26)

A user equipment, UE, comprising:
means for transmitting, to a network node, a first measurement report indicating a result of a first measurement performed by the UE;
means for receiving, from the network node, an indication to cause the UE to transmit, to another network node, a second measurement report indicating a result of a second measurement performed by the UE, in a Radio Resource Control, RRC, Reconfiguration Complete message, after the first measurement report is transmitted to the network node;
means for transmitting the second measurement report to the another network node, and
wherein the second measurement report is used for generating a feedback of a predicted mobility of the UE.

This application is based upon and claims the benefit of priority from United Kingdom applications No. 2301235.4, filed on Jan. 27, 2023, the disclosure of which is incorporated herein in its entirety by reference.

### REFERENCE SIGNS LIST

1 COMMUNICATION SYSTEM
3 USER EQUIPMENT
5, 5-1, 5-2, 5-3 RAN NODE (BASE STATION, RAN EQUIPMENT)
7 CORE NETWORK
9 CELL
CPF
10-1 AMF
10-2 SMF
11 UPF
41 DATA COLLECTION FUNCTION
43 MODEL TRAINING FUNCTION
MODEL INFERENCE FUNCTION
47 ACTOR
50, 50a, 50b DU
60 CU
451 TRANSCEIVER CIRCUIT
453 RU INTERFACE
454 CU INTERFACE
457 CONTROLLER
459 MEMORY
461 OPERATING SYSTEM
463 COMMUNICATIONS CONTROL MODULE
465 F1 MODULE
468 DU-RU MODULE
472 DU MANAGEMENT MODULE
473 UE PROFILE MANAGEMENT MODULE
475 MOBILITY MODULE
551 TRANSCEIVER CIRCUIT
554 DU INTERFACE
555 CU INTERFACE
557 CONTROLLER
559 MEMORY
561 OPERATING SYSTEM
563 COMMUNICATIONS CONTROL MODULE
565 F1 MODULE
566 E1 MODULE
568 N2 MODULE
569 N3 MODULE
571 CU-UP MANAGEMENT MODULE
572 CU-CP MANAGEMENT MODULE
573 UE PROFILE MANAGEMENT MODULE
575 MOBILITY MODULE

What is claimed is:

1.-26. (canceled)

27. A method of a network node, the method comprising:
transmitting a handover request message including predicted mobility information indicating a predicted trajectory of a mobile device, to another network node for mobility of the mobile device; and
receiving, from the another network node, feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

28. The method according to claim 27, wherein
granularity of the information indicating the predicted trajectory corresponds to cell level.

29. The method according to claim 27, wherein
the predicted mobility information includes information indicating an accuracy of the predicted mobility, including at least one of:
information indicating an accuracy that the mobile device will be in a corresponding location; or
information indicating an accuracy of a duration that the mobile device will stay in the corresponding location.

30. The method according to claim 27, wherein
the predicted mobility information includes information indicating an accuracy of the predicted mobility per location included in the predicted trajectory of the mobile device.

31. The method according to claim 27, wherein
the predicted mobility information includes at least one of:
a type of mobility of the mobile device;
a speed or velocity of the mobile device;
a type of mobile device; or
a previous location of the mobile device.

32. The method according to claim 27, wherein
the predicted mobility information is transmitted via a core network node to the another network node.

33. The method according to claim 27, wherein
the feedback information is based on a measurement report transmitted from the mobile device.

34. The method according to claim 33, further comprising:
transmitting, to the mobile device, a report indication to cause the mobile device to include the measurement report in a Radio Resource Control (RRC) Reconfiguration Complete message, wherein
the measurement report is transmitted from the mobile device based on the report indication.

35. The method according to claim 33, wherein
the feedback information includes the measurement report.

36. The method according to claim 27, further comprising:
using the feedback information to determine an accuracy of the predicted mobility, or using the feedback information as the input into a mobility model to generate a further predicted mobility of the mobile device.

37. The method according to claim 27, wherein
granularity of the feedback information corresponds to cell level.

38. The method according to claim 27, further comprising:
transmitting, to the another network node, configuration of a mobility model, and
wherein the configuration of the mobility model includes:
information indicating at least one use case for the mobility model, and
a respective framework of the mobility model per the at least one use case.

39. The method according to claim 38, wherein
the respective framework includes information indicating at least one of:
granularity of a trajectory of the mobile device,
need of a feedback of performance of the mobile device, or
need of a feedback of an accuracy of a trajectory of the mobile device.

40. A method of a network node, the method comprising:
receiving, from another network node, a handover request message including predicted mobility information indicating a predicted trajectory of a mobile device, for mobility of the mobile device; and
transmitting, to the another network node, feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

41. A method of a core network node, the method comprising:
receiving, from a network node, predicted mobility information indicating a predicted trajectory of a mobile device, for mobility of the mobile device; and
transmitting the predicted mobility information to another network node,
wherein the predicted mobility information is used by the another network node to transmit feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

42. A method of a mobile device, the method comprising:
transmitting, to a network node, a first measurement report indicating a result of a measurement performed by the mobile device;
receiving, from the network node, an indication to cause the mobile device to transmit, to another network node, a second measurement report indicating a result of a second measurement performed by the mobile device, in a Radio Resource Control (RRC) Reconfiguration Complete message, after the first measurement report is transmitted to the network node; and
transmitting the second measurement report to the another network node, and
wherein the second measurement report is used for generating feedback information of a predicted trajectory of the mobile device,
wherein the feedback information includes an actual trajectory of the mobile device and is based on the predicted trajectory of the mobile device indicated by predicted mobility information,
wherein the predicted mobility information includes identity information indicating at least one data collection transaction, and
wherein the feedback information includes the identity information indicating the at least one data collection transaction.

43. An access network node comprising:
at least one memory storing instructions; and
at least one processor configured to execute the instructions to:
transmit, a handover request message including predicted mobility information indicating a predicted trajectory of a mobile device, to the another network node for mobility of the mobile device; and
receive, from the another network node, feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

44. An access network node comprising:
at least one memory storing instructions; and
at least one processor configured to execute the instructions to:
receive, from another network node, a handover request message including predicted mobility information indicating a predicted trajectory of the mobile device, for mobility of the mobile device; and
transmit, to the another network node, feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

45. A core network node comprising:
at least one memory storing instructions; and
at least one processor configured to execute the instructions to:
receive, from a network node, predicted mobility information indicating a predicted mobility of a mobile device, for mobility of the mobile device; and
transmit the predicted mobility information to another access network node,
wherein the predicted mobility information is used by the another network node to transmit feedback information indicating an actual trajectory of the mobile device after successful mobility of the mobile device,
wherein the predicted mobility information includes identity information indicating at least one data collection transaction, and
wherein the feedback information includes the identity information indicating the at least one data collection transaction.

46. A mobile device comprising:
at least one memory storing instructions; and
at least one processor configured to execute the instructions to:
transmit, to a network node, a first measurement report indicating a result of a first measurement performed by the mobile device;
receive, from the network node, an indication to cause the mobile device to transmit, to another network node, a second measurement report indicating a result of a second measurement performed by the mobile device, in a Radio Resource Control (RRC) Reconfiguration Complete message, after the first measurement report is transmitted to the network node;
transmit the second measurement report to the another network node, and
wherein the second measurement report is used for generating a feedback of a predicted mobility of the mobile device,
wherein the feedback information includes an actual trajectory of the mobile device and is based on the predicted trajectory of the mobile device indicated by predicted mobility information,
wherein the predicted mobility information includes identity information indicating at least one data collection transaction, and
wherein the feedback information includes the identity information indicating the at least one data collection transaction.
